(19) United States
(12) Patent Application Publication
(10) Pub. No.: US 2018/0118925 A1
(43) Pub. Date: May 3, 2018

(54) DEGRADABLE RUBBER COMPOSITIONS

(71) Applicant: WEIR SLURRY GROUP, INC., Madison, WI (US)

(72) Inventors: Francisco A. Gozalo, Sandy, UT (US); Sanford W. Clark, Salt Lake City, UT (US)

(21) Appl. No.: 15/803,541

(22) Filed: Nov. 3, 2017

Related U.S. Application Data
(60) Provisional application No. 62/417,143, filed on Nov. 3, 2016.

(51) Int. Cl. C08L 7/00; C08L 13/00; C08L 75/04; C08K 3/16; C08K 3/30; C09K 3/10; E21B 33/12

(52) U.S. Cl. CPC C08L 7/00; C08L 13/00; C08L 75/04; C08K 3/16; C08K 3/30; C09K 3/1021; C09K 2200/065; C08K 2003/168; C08K 2003/3009; C09K 2003/104; C09K 2003/1053; C09K 2200/0607; E21B 33/1208

(57) ABSTRACT

This disclosure relates to degradable rubber compositions, such as those, for example, comprising at least one natural rubber; at least one polyurethane; at least one curing agent; and at least one complex using zinc chloride and a disulfide, wherein the degradable rubber composition is degradable in an aqueous composition.

### CROSS-REFERENCE TO RELATED APPLICATIONS

This application claims priority to U.S. Provisional Application No. 62/417,143 filed Nov. 3, 2016, the entire contents of which are hereby incorporated in their entirety by reference.

### FIELD OF THE DISCLOSURE

The present disclosure relates, in some embodiments, to degradable rubber compositions and, more particularly, to degradable rubber compositions for use with oil and gas field equipment including, for example, degradable swellable packers. The present disclosure also relates, in some embodiments, to systems and methods for sealing a region between a wellbore wall and a degradable swellable packer-conduit assembly.

### BACKGROUND OF THE DISCLOSURE

After deployment of a swellable packer in a wellbore, retrieval may become necessary or desirable. Currently practiced methods of retrieving swellable packers from wellbores may be labor intensive, may involve the use of additional mechanical equipment that increases the amount of damage to the wellbore itself, and may increase the monetary cost of the operation. Some methods also involve the introduction of hazardous chemicals to dissolve elements of the swellable packer to facilitate swellable packer retrieval. These hazardous chemical increase the environmental impact on the wellbore site and surrounding areas while potentially damaging co-existing equipment being used in the wellbore hole.

### SUMMARY

Accordingly, a need has arisen for improved degradable rubber swellable packers that may not need to be retrieved from a wellbore, and may not increase the environmental impact on the wellbore site or necessitate the use of hazardous chemicals.

The present disclosure relates, according to some embodiments, to a degradable rubber composition which may comprise: at least one natural rubber; at least one polyurethane; at least one sulfur curing agent; and at least one complex comprising zinc chloride and a disulfide, wherein the degradable rubber composition may be degradable in an aqueous composition. A degradable rubber may comprise at least one carbon black; at least one zinc soap; at least one vulcanization accelerant; at least one polymerization accelerant; at least one stearic acid; or combinations thereof. In some embodiments, an aqueous composition may be selected from the group consisting of water, water solutions, downhole water-based solutions, aqueous-based solutions, and at least one brine. A degradable rubber composition may degrade from about 25% to about 90% within a period of time, the period of time selected from the group consisting of about 1 day, about 3 days, about 7 days, about 14 days, about 21 days, and about 28 days. A degradable rubber composition may degrade from about 25% to about 90% at a temperature, the temperature selected from the group consisting of about 50° F. (10° C.), about 75° F. (23.9° C.), about 100° F. (37.8° C.), about 125° F. (51.7° C.), about 150° F. (65.6° C.), about 175° F. (79.4° C.), about 200° F. (93.3° C.), about 225° F. (107.2° C.), about 250° F. (121.1° C.), about 275° F. (135° C.), and about 300° F. (148.9° C.). In some embodiments, a degradable rubber composition may degrade from about 25% to about 90% within about 14 days at about 200° F. (93.3° C.). At least one natural rubber may be present at a concentration ranging from about 10 wt. % to about 60 wt. % of the degradable rubber composition. At least one polyurethane may be present at a concentration ranging from about 40 wt. % to about 70 wt. % of the degradable rubber composition. In some embodiments, at least one complex may be present at a concentration ranging from about 0.8 wt. % to about 3.0 wt. % of the degradable rubber composition. At least one sulfur curing agent may be present at a concentration ranging from about 0.8 wt. % to about 3.0 wt. % of the degradable rubber composition. A degradable rubber composition may be used in a swellable packer-conduit assembly, according to some embodiments.

According to some embodiments, the present disclosure relates to a degradable swellable packer-conduit assembly comprising: at least one conduit; and at least one degradable rubber composition, wherein the at least one degradable rubber composition comprises: at least one natural rubber; at least one polyurethane; at least one sulfur curing agent; and at least one complex comprising zinc chloride and a disulfide, wherein the at least one degradable rubber composition may be degradable in an aqueous composition. An aqueous composition may be selected from the group consisting of water, water solutions, downhole water-based solutions, aqueous-based solutions, and at least one brine. A degradable rubber composition may degrade from about 25% to about 90% within a period of time, the period of time selected from the group consisting of about 1 day, about 3 days, about 7 days, about 14 days, about 21 days, and about 28 days. A degradable rubber composition may degrade from about 25% to about 90% at a temperature, the temperature selected from the group consisting of about 50° F. (10° C.), about 75° F. (23.9° C.), about 100° F. (37.8° C.), about 125° F. (51.7° C.), about 150° F. (65.6° C.), about 175° F. (79.4° C.), about 200° F. (93.3° C.), about 225° F. (107.2° C.), about 250° F. (121.1° C.), about 275° F. (135° C.), and about 300° F. (148.9° C.). A degradable rubber composition may degrade from about 25% to about 90% within about 14 days at about 200° F. (93.3° C.). At least one natural rubber may be present at a concentration ranging from about 10 wt. % to about 60 wt. % of the degradable rubber composition. At least one polyurethane may be present at a concentration ranging from about 40 wt. % to about 70 wt. % of the degradable rubber composition. According to some embodiments, at least one complex may be present at a concentration ranging from about 0.8 wt. % to about 3.0 wt. % of the degradable rubber composition.

According to some embodiments, at least one sulfur curing agent may be present at a concentration ranging from about 0.8 wt. % to about 3.0 wt. % of the degradable rubber composition. A degradable rubber composition may be capable of swelling upon contacting an aqueous composition, wherein the degradable rubber composition has already been cured. An aqueous composition may be selected from or comprise water, water solutions, downhole water-based solutions, aqueous-based solutions, at least one brine, and combinations thereof. A degradable rubber composition may be capable of swelling at a temperature of at least about 275° F. (135° C.). In some embodiments, a degradable rubber composition may be capable of swelling at a pressure, the pressure selected from the group consisting of at least about 3,000 psi (20,684 kPa), at least about 4,000 psi (27,579 kPa), at least about 5,000 psi (34,474 kPa), at least about 6,000 psi (41,369 kPa), at least about 7,000 psi (48,263 kPa), at least about 8,000 psi (55,158 kPa), at least about 10,000 psi (68,948 kPa) and at least about 11,000 psi (75,842, kPa).

According to some embodiments, the present disclosure relates to a method of sealing an annular region between a wellbore wall and a degradable swellable packer-conduit assembly, the method comprising: (a) disposing the degradable swellable packer-conduit assembly between the wellbore wall and a pipe; and (b) contacting at least a portion of the degradable swellable packer-conduit assembly with an aqueous composition, wherein the degradable swellable packer-conduit assembly comprises at least one conduit and at least one degradable rubber composition, the at least one degradable rubber composition comprising: at least one natural rubber; at least one polyurethane; at least one sulfur curing agent; and at least one complex comprising zinc chloride and a disulfide, wherein the degradable rubber composition may be degradable in an aqueous composition. In some embodiments, a method may comprise (c) degrading at least a portion of the degradable swellable packer-conduit assembly. An aqueous composition may comprise or be selected from water, water solutions, downhole water-based solutions, aqueous-based solutions, at least one brine, or combinations thereof. A degradable rubber composition may degrade from about 25% to about 90% within a period of time, the period of time selected from the group consisting of about 1 day, about 3 days, about 7 days, about 14 days, about 21 days, and about 28 days. A degradable rubber composition may degrade from about 25% to about 90% at a temperature, the temperature selected from the group consisting of about 50° F. (10° C.), about 75° F. (23.9° C.), about 100° F. (37.8° C.), about 125° F. (51.7° C.), about 150° F. (65.6° C.), about 175° F. (79.4° C.), about 200° F. (93.3° C.), about 225° F. (107.2° C.), about 250° F. (121.1° C.), about 275° F. (135° C.), and about 300° F. (148.9° C.). A degradable rubber composition may degrade from about 25% to about 90% within about 14 days at about 200° F. (93.3° C.). In some embodiments, at least one natural rubber may be present at a concentration ranging from about 10 wt. % to about 60 wt. % of the degradable rubber composition. At least one polyurethane may be present at a concentration ranging from about 40 wt. % to about 70 wt. % of the degradable rubber composition. At least one complex may be present at a concentration ranging from about 0.8 wt. % to about 3.0 wt. % of the degradable rubber composition. At least one sulfur curing agent may be present at a concentration ranging from about 0.8 wt. % to about 3.0 wt. % of the degradable rubber composition. According to some embodiments, a degradable swellable packer-conduit assembly may swell by about 20% to about 250% by volume, wherein the degradable swellable packer-conduit assembly may be subjected to a pressure, the pressure selected from the group consisting of at least about 3,000 psi (20,684 kPa) , at least about 4,000 psi (27,579 kPa), at least about 5,000 psi (34,474 kPa), at least about 6,000 psi (41,369 kPa), at least about 7,000 psi (48,263 kPa), at least about 8,000 psi (55,158 kPa), and at least about 10,000 psi (68,948 kPa). A degradable swellable packer-conduit assembly may swell by about 20% to about 250% by volume, wherein swelling occurs within a period of time, the period of time selected from the group consisting of about 1 day, about 2 days, about 3 days, about 4 days, and about 5 days.

The present disclosure relates, according to some embodiments, to a method comprising: (a) disposing a swellable packer-conduit assembly between a wellbore wall and a pipe; (b) contacting at least a portion of the degradable swellable packer-conduit assembly with an aqueous composition; and (c) degrading at least a portion of the degradable swellable packer-conduit assembly, wherein the degradable swellable packer-conduit assembly comprises a conduit and at least one degradable rubber composition, the at least one degradable rubber composition comprising: at least one natural rubber; at least one polyurethane; at least one sulfur curing agent; and at least one complex comprising zinc chloride and a disulfide. A degradable rubber composition may degrade from about 25% to about 90% within a period of time, the period of time selected from the group consisting of about 1 day, about 3 days, about 7 days, about 14 days, about 21 days, and about 28 days. A degradable rubber composition may degrade from about 25% to about 90% at a temperature, the temperature selected from the group consisting of about 50° F. (10° C.), about 75° F. (23.9° C.), about 100° F. (37.8° C.), about 125° F. (51.7° C.), about 150° F. (65.6° C.), about 175° F. (79.4° C.), about 200° F. (93.3° C.), about 225° F. (107.2° C.), about 250° F. (121.1° C.), about 275° F. (135° C.), and about 300° F. (148.9° C.). A degradable rubber composition may degrade from about 25% to about 90% within about 14 days at about 200° F. (93.3° C.). A degradable swellable packer-conduit assembly may swell by about 20% to about 250% by volume, wherein the degradable swellable packer-conduit assembly may be subjected to a pressure, the pressure selected from the group consisting of at least about 3,000 psi (20684 kPa), at least about 4,000 psi (27,579 kPa), at least about 5,000 psi (34,474 kPa), at least about 6,000 psi (41,369 kPa), at least about 7,000 psi (48,263 kPa), and at least about 8,000 psi (55,158 kPa). According to some embodiments, a degradable swellable packer-conduit assembly may swell by about 20% to about 250% by volume, wherein swelling occurs within a period of time, the period of time selected from the group consisting of about 1 day, about 2 days, about 3 days, about 4 days, and about 5 days. At least one natural rubber may be present at a concentration ranging from about 10 wt. % to about 60 wt. % of the degradable rubber composition. At least one polyurethane may be present at a concentration ranging from about 40 wt. % to about 70 wt. % of the degradable rubber composition. At least one complex may be present at a concentration ranging from about 0.8 wt. % to about 3.0 wt. % of the degradable rubber composition. At least one sulfur curing agent may be present at a concentration ranging from about 0.8 wt. % to about 3.0 wt. % of the degradable rubber composition.

### BRIEF DESCRIPTION OF THE DRAWINGS

Some embodiments of the disclosure may be understood by referring, in part, to the present disclosure and the accompanying drawings, wherein:

FIG. 1 a sectional view of a degradable swellable packer assembly comprising a rubber coating surrounding a conduit and capable of swelling in the presence of an aqueous composition and/or aqueous composition formations according to a specific example embodiment of the disclosure;

FIG. 2 illustrates a view of degradable rubber compositions dumbbell shaped samples and compression set buttons, according to a specific example embodiment of the disclosure;

FIG. 3 illustrates differing levels of reversion related to the ratio of polyurethane to natural rubber of degradable rubber compositions, according to a specific example embodiment of the disclosure;

FIG. 4 illustrates degradable rubber compositions after three days of immersion, according to specific example embodiments of the disclosure;

FIG. 5 illustrates degradable rubber compositions after eight days of immersion, according to specific example embodiments of the disclosure;

FIG. 6 illustrates degradable rubber compositions after 14 days of immersion, according to specific example embodiments of the disclosure;

FIG. 7 illustrates degradable rubber compositions after 21 days of immersion, according to specific example embodiments of the disclosure;

FIG. 8 illustrates degradable rubber compositions flakes remaining in sample container, according to specific example embodiments of the disclosure;

FIG. 9 illustrates degradable rubber compositions after 28 days of immersion, according to specific example embodiments of the disclosure;

FIG. 10 illustrates a separated compression set button of a degradable rubber composition, according to specific example embodiments of the disclosure;

FIG. 11 illustrates hardness measurements of degradable rubber compositions over the course of 28 days, according to a specific example embodiment of the disclosure;

FIG. 12 illustrates tensile strength measurements of degradable rubber compositions over the course of 28 days, according to a specific example embodiment of the disclosure; and

FIG. 13 illustrates change in elongation measurements of degradable rubber compositions over the course of 28 days, according to a specific example embodiment of the disclosure.

### DETAILED DESCRIPTION

The present disclosure relates, in some embodiments, to degradable rubber compositions. In some embodiments, a degradable rubber composition may be used with oil and gas field equipment, including, for example, swellable packers and/or cured packers. In some embodiments, swellable packers comprising at least one degradable rubber composition, may be easier to retrieve than their non-degradable counterparts or may not need to be retrieved from a wellbore. The present disclosure, in some embodiments, relates to compositions and methods for sealing an annular region between a wellbore wall and a degradable swellable packer-conduit assembly. For example, a method may comprise disposing a degradable swellable packer-conduit assembly between a wellbore wall and a pipe and contacting at least a portion of the degradable swellable packer-conduit assembly with an aqueous composition, wherein the degradable swellable packer-conduit assembly comprises at least one conduit and at least one degradable rubber composition. A degradable rubber composition may be degradable in an aqueous composition, according to some embodiments. In some embodiments, the present disclosure relates to compositions and methods for degrading a degradable swellable packer-conduit assembly. For example, a method of degrading a degradable swellable packer-conduit assembly may comprise disposing a swellable packer-conduit assembly between a wellbore wall and a pipe, contacting at least a portion of the degradable swellable packer-conduit assembly with an aqueous composition, degrading at least a portion of the degradable swellable packer-conduit assembly, wherein the degradable swellable packer-conduit assembly comprises a conduit and at least one degradable rubber composition.

### Degradable Rubber Compositions

In some embodiments, a degradable rubber composition and/or cured packer may comprise an elastomer, such as a thermoset elastomer capable of withstanding high temperatures for a prolonged period of time and that swells in the presence of an aqueous composition (e.g., water or a water-based fluid) and/or in the presence of an oil- or hydrocarbon-based fluid. In some embodiments, a degradable rubber composition comprising an elastomer may be degradable in an aqueous composition. An elastomer may comprise, for example: natural rubber (NR), polyurethane, butadiene acrylonitrile copolymer, nitrile rubber, liquid polybutadiene (Liquid PBD), NBR, hydrogenated nitrile rubber, hydrogenated NBR, highly saturated nitrile, HNR, HNBR, carboxylated NBR (XNBR), chloroprene rubber (CR), ethylene propylene diene terpolymer (EPDM), acrylic rubber (ACM), styrene-butadiene rubber (SBRS, polybutadiene/butadiene rubber (BR), low acrylonitrile nitrile (a low ACN nitrile), synthetic polyisoprene, butyl rubbers (IIR), chlorosulphonated polyethylene (CSM), silicone, fluoro rubbers, perfluoro rubbers, tetrafluoro ethylene propylene rubber (FEPM), and combinations thereof.

According to some embodiments, a degradable rubber composition and/or cured packer may comprise at least one natural rubber (e.g., polyisoprene). In some embodiments, a degradable rubber composition may comprise an at least one natural rubber content of about 10 wt. %, or about 15 wt. %, or about 20 wt. %, or about 25 wt. %, or about 30 wt. %, or about 35 wt. %, or about 40 wt. %, or about 50 wt. %, or about 55 wt. %, or about 60 wt. % of the degradable rubber composition and/or cured packer. In this context, “about” may constitute a range above or below the reference wt. % value (e.g., plus or minus≤5 wt. %). In some embodiments, a degradable rubber composition may comprise about 5 parts per hundred rubber (Phr) of at least one natural rubber, or about 10 Phr of at least one natural rubber, or about 15 Phr of at least one natural rubber, or about 20 Phr of at least one natural rubber, or about 25 Phr of at least one natural rubber, or about 30 Phr of at least one natural rubber, or about 35 Phr of at least one natural rubber, or about 40 Phr of at least one natural rubber, or about 45 Phr of at least one natural rubber, or about 50 Phr of at least one natural rubber. In this context, “about” may constitute a range above or below the reference Phr value (e.g., plus or minus≤5 Phr). In some embodiments, at least one natural rubber comprises, cis-1,4-polyisoprene, trans-1,4-polyisoprene, or combinations thereof.

According to some embodiments, a degradable rubber composition and/or cured packer may comprise at least one polyurethane (e.g., Millethane 76). In some embodiments, a degradable rubber composition may comprise an at least one polyurethane content of about 40 wt. %, or about 45 wt. %, or about 50 wt. %, or about 55 wt. %, or about 60 wt. %, or about 65 wt. %, or about 70 wt. %, or about 75 wt. %, or about 80 wt. %, or about 85 wt. % of the degradable rubber composition and/or cured packer. In this context, “about” may constitute a range above or below the reference wt. % value (e.g., plus or minus≤5 wt. %). In some embodiments, a degradable rubber composition may comprise about 30 Phr of at least one polyurethane, or about 35 Phr of at least one polyurethane, or about 40 Phr of at least one polyurethane, or about 45 Phr of at least one polyurethane, or about 50 Phr of at least one polyurethane, or about 55 Phr of at least one polyurethane, or about 60 Phr of at least one polyurethane, or about 65 Phr of at least one polyurethane, or about 70 Phr of at least one polyurethane, or about 75 Phr of at least one polyurethane. In this context, “about” may constitute a range above or below the reference Phr value (e.g., plus or minus≤5 Phr). In some embodiments, at least one polyurethane comprises millable polyurethanes and castable polyurethanes.

According to some embodiments, a degradable rubber composition and/or cured packer may comprise a hydrogenated nitrile butadiene rubber (e.g., HNBR Zetpol 2030L, Therban 3496). For example, at least one nitrile rubber elastomer may be a hydrogenated nitrile elastomer having a percent hydrogenation from about 70% to bout 91%. According to some embodiments, a hydrogenated nitrile elastomer may have a Mooney viscosity ML 1+4 (100 degrees Celsius) of about 47 to about 72. In some embodiments, a hydrogenated nitrile elastomer may have a Mooney viscosity ML 1+4 (100 degrees Celsius) of about 30, or about 35, or about 40, or about 45, or about 50, or about 55, or about 60, or about 65, or about 70, or about 75, or about 80. In this context, “about” may constitute a range above or below the reference viscosity (e.g., plus or minus≤5). In other embodiments, a hydrogenated nitrile elastomer may have a percent unsaturation of about 9 percent to about 30 percent. According to some embodiments, a hydrogenated nitrile elastomer may have a percent unsaturation of about 5%, or about 10%, or about 15%, or about 20%, or about 25%, or about 30%, or about 35%, or about 40%. In this context, “about” may constitute a range above or below the reference percentage (e.g., plus or minus≤5%). Examples of the hydrogenated nitrile elastomer that are commercially available from Zetpol® include 0020, 1020L, 2020L, and 2030L.

According to some embodiments, a degradable rubber composition and/or cured packer may comprise a hydrogenated nitrile butadiene rubber (e.g., HNBR Zetpol 2030L, Therban 3496) content of about 0.5 wt. %, of about 1 wt. %, or of about 2 wt. %, or of about 3 wt. %, or of about 4 wt. %, or of about 5 wt. %, or of about 6 wt. %, or of about 7 wt. %, or of about 8 wt. %, or of about 9 wt. %, or of about 10 wt. %, or of about 15 wt. % of the degradable rubber composition and/or cured packer. In this context, “about” may constitute a range above or below the reference wt. % value (e.g., plus or minus≤2 wt. %).

According to some embodiments, a degradable rubber composition and/or cured packer may comprise a styrene-butadiene rubber (e.g., 1502 SBR) content of about 5 wt. %, of about 10 wt. %, or of about 15 wt. %, or of about 20 wt. %, or of about 25 wt. %, or of about 30 wt. %, or of about 35 wt. %, or of about 40 wt. %, or of about 45 wt. % of the degradable rubber composition and/or cured packer. In this context, “about” may constitute a range above or below the reference wt. % value (e.g., plus or minus≤5 wt. %).

According to some embodiments, a degradable rubber composition and/or cured packer may comprise a polybutadiene (e.g., liquid PBD—PolyBD R20LM, Nitroflex Liquid Nitrile, Liquid EPDM) content of about 0.5 wt. %, of about 1 wt. %, or of about 2 wt. %, or of about 3 wt. %, or of about 4 wt. %, or of about 5 wt. %, or of about 6 wt. %, or of about 7 wt. %, or of about 8 wt. %, or of about 9 wt. %, or of about 10 wt. %, or of about 15 wt. % of the degradable rubber composition and/or cured packer. In this context, “about” may constitute a range above or below the reference wt. % value (e.g., plus or minus≤2.5 wt. %).

According to some embodiments, a degradable rubber composition and/or cured packer may comprise a low ACN nitrile (e.g., Perbunan 1846 F) content of about 5 wt. %, of about 10 wt. %, or of about 15 wt. %, or of about 20 wt. %, or of about 25 wt. %, or of about 30 wt. %, or of about 35 wt. %, or of about 40 wt. %, or of about 45 wt. % of the degradable rubber composition and/or cured packer. In this context, “about” may constitute a range above or below the reference wt. % value (e.g., plus or minus≤5 wt. %).

In some embodiments, a degradable rubber composition and/or cured packer may also comprise a cement, a Portland cement, and one or more reactive filler materials, such as cement, cementations material, metal oxide, and mixtures thereof, which react and swell upon contact with an aqueous composition. In some embodiments, a degradable rubber composition may stiffen upon contact with an aqueous composition. In some embodiments, a cement may result in improvements in the physical properties of the rubber, such as increased volume and increased modulus. For example, a filler may be a reactive filler, a reinforcing reactive filler, a sealing system, a cement clinker, a silicate, a aluminate, a ferrite and/or combinations thereof.

According to some embodiments, a degradable rubber composition and/or cured packer may comprise at least one peptizer (e.g., zinc stearate). In some embodiments, a degradable rubber composition may comprise at least one peptizer content of about 0.1 wt. %, or about 0.2 wt. %, or about 0.3 wt. %, or about 0.4 wt. %, or about 0.5 wt. %, or about 0.6 wt. %, or about 0.7 wt. %, or about 0.8 wt. %, or about 0.9 wt. %, or about 1.0 wt. % of the degradable rubber composition and/or cured packer. In this context, “about” may constitute a range above or below the reference wt. % value (e.g., plus or minus≤0.1 wt. %). In some embodiments, a degradable rubber composition may comprise about 5 Phr of at least one peptizer, or about 0.4 Phr of at least one peptizer, or about 0.6 Phr of at least one peptizer, or about 0.8 Phr of at least one peptizer, or about 1.0 Phr of at least one peptizer, or about 1.2 Phr of at least one peptizer, or about 1.4 Phr of at least one peptizer, or about 1.6 Phr of at least one peptizer, or about 1.8 Phr of at least one peptizer, or about 2 Phr of at least one peptizer. In this context, “about” may constitute a range above or below the reference Phr value (e.g., plus or minus≤0.2 Phr). In some embodiments, at least one peptizer comprises at least one physical peptizer, at least chemical peptizer, or combinations thereof. According to some embodiments, a peptizer may facilitate filler incorporation, facilitate dispersion of compounding materials, improve elastomer blends, reduce processing temperatures, improve flow properties, enhance building tack, or combinations thereof.

According to some embodiments, a degradable rubber composition and/or cured packer may comprise a zinc soap. Without being limited to any specific mechanism of action, the presence or absence of a zinc soap (and if present, the concentration of the zinc soap) in a degradable rubber composition may impact a rate at which the degradable rubber composition may degrade, decompose, breakdown of mechanical properties, or a combination thereof. For example, a zinc soap may be included in a degradable rubber composition to activate rubber vulcanization, act as a phase transfer catalyst, function as a releasing agent for a degradable rubber from a surface, or a combination thereof. Also, a zinc soap may desirably facilitate degradation or autocatalytic degradation of a degradable rubber composition. A zinc soap may desirably accelerate an autocatalytic process, for example, through hydrolysis of ester linkage groups contained within a degradable rubber composition and/or cured packer. A zinc soap may comprise a zinc source (e.g., zinc oxide) and at least one fatty acid source. A fatty acid source may comprise at least one fatty acid comprising C1-20 alkyl, C1-20 alkyl alcohol, C1-20 monounsaturated alkyl, C1-20 polyunsaturated alkyl, wherein each stereoisomer is selected from the group consisting of E, Z, R, S, and a combination thereof.

In some embodiments, a degradable rubber composition and/or cured packer may also comprise a tackifier. In some embodiments, a tackifier may comprise resins (i.e., hydrocarbon resins, phenolic-formaldehyde resin, coumarone-indene resin, and Struktol Koresin). According to some embodiments, a tackifier may result in an increase of tack (e.g., stickiness of the surface).

In some embodiments, a degradable rubber composition and/or cured packer may also comprise an antiozonant. In some embodiments, an antiozonant may comprise phenylenediamines (e.g., N-(1,3-Dimethylbutyl)-N-phenyl-phenylenediamine), diureas (e.g., ethylene diurea), and paraffin waxes. According to some embodiments, an antiozonant may protect the degradable rubber composition and/or the cured packer from ozone.

In some embodiments, a degradable rubber composition and/or cured packer may also comprise a vulcanization inhibitor. In some embodiments, a vulcanization inhibitor may comprise a phthalimide (e.g., cyclohexylthiophthalimide), diureas (e.g., ethylene diurea), and paraffin waxes. According to some embodiments, an antiozonant may protect the degradable rubber composition and/or the cured packer from ozone.

In some embodiments, a degradable rubber composition and/or cured packer may also comprise a vulcanization accelerant. In some embodiments, a vulcanization accelerant may comprise aldehyde amines, guanidines, thiazoles, thiophosphates, sulfonamides, thioureas, thiuram, dithiocarbamates, xanthanes. In some embodiments, a vulcanization accelerant may comprise tetramethyl thiuram disulfide, mercaptobenzthiazole disulfide, tetramethyl thiuram monosulfide, dipentamethylene thiuram, zinc chloride, tetrabenzylthiuram disulfide, or combinations thereof. According to some embodiments, a tackifier may result in an increase of vulcanization speed and may permit vulcanization to progress at lower temperatures.

According to some embodiments, a degradable rubber composition and/or cured packer may comprise a vulcanization accelerant (e.g., MBTS, Thanecure ZM, benzothiazole disulfide) content of about 0.8 wt. %, of about 1.0 wt. %, or of about 1.2 wt. %, or of about 1.4 wt. %, or of about 1.6 wt. %, or of about 1.8 wt. %, or of about 2.0 wt. %, or of about 2.2 wt. %, or of about 2.4 wt. %, or of about 2.6 wt. %, or of about 2.8 wt. %, or of about 3.0 wt. % of the degradable rubber composition and/or cured packer. In this context, “about” may constitute a range above or below the reference wt. % value (e.g., plus or minus≤0.2 wt. %). In some embodiments, a degradable rubber composition may comprise about 0.8 parts per hundred rubber (Phr) of at least one vulcanization accelerant, or about 1.0 Phr of at least one vulcanization accelerant, or about 1.2 Phr of at least one vulcanization accelerant, or about 1.4 Phr of at least one vulcanization accelerant, or about 1.6 Phr of at least one vulcanization accelerant, or about 1.8 Phr of at least one vulcanization accelerant, or about 2.0 Phr of at least one vulcanization accelerant, or about 2.2 Phr of at least one vulcanization accelerant, or about 2.4 Phr of at least one vulcanization accelerant, or about 2.6 Phr of at least one vulcanization accelerant, or about 2.8 Phr of at least one vulcanization accelerant, or about 3.0 Phr of at least one vulcanization accelerant, or about 3.5 Phr of at least one vulcanization accelerant, or about 4.0 Phr of at least one vulcanization accelerant. In this context, “about” may constitute a range above or below the reference Phr value (e.g., plus or minus≤0.25 Phr). In some embodiments, a vulcanization accelerant may accelerate the vulcanization of a degradable rubber composition and/or cured packer.

According to some embodiments, a degradable rubber composition and/or cured packer may comprise at least one complex comprising zinc chloride and a disulfide (e.g., Thanecure ZM), wherein the degradable rubber composition and/or cured packer comprises the at least one complex at a content of about 0.8 wt. %, of about 1.0 wt. %, or of about 1.2 wt. %, or of about 1.4 wt. %, or of about 1.6 wt. %, or of about 1.8 wt. %, or of about 2.0 wt.

%, or of about 2.2 wt. %, or of about 2.4 wt. %, or of about 2.6 wt. %, or of about 2.8 wt. %, or of about 3.0 wt. % of the degradable rubber composition and/or cured packer. In this context, “about” may constitute a range above or below the reference wt. % value (e.g., plus or minus≤0.25 wt. %). In some embodiments, a degradable rubber composition may comprise about 0.8 parts per hundred rubber (Phr) of at least one complex, or about 1.0 Phr of at least one complex, or about 1.2 Phr of at least one complex, or about 1.4 Phr of at least one complex, or about 1.6 Phr of at least one complex, or about 1.8 Phr of at least one complex, or about 2.0 Phr of at least one complex, or about 2.2 Phr of at least one complex, or about 2.4 Phr of at least one complex, or about 2.6 Phr of at least one complex, or about 2.8 Phr of at least one complex, or about 3.0 Phr of at least one complex, or about 3.5 Phr of at least one complex, or about 4.0 Phr of at least one complex. In this context, “about” may constitute a range above or below the reference Phr value (e.g., plus or minus≤0.25 Phr).

According to some embodiments, a degradable rubber composition and/or cured packer may comprise a polymerization accelerant (e.g., tetrabenzyl thiuram disulfide) content of about 0.8 wt. %, of about 1.0 wt. %, or of about 1.2 wt. %, or of about 1.4 wt. %, or of about 1.6 wt. %, or of about 1.8 wt. %, or of about 2.0 wt. %, or of about 2.2 wt. %, or of about 2.4 wt. %, or of about 2.6 wt. %, or of about 2.8 wt. %, or of about 3.0 wt. % of the degradable rubber composition and/or cured packer. In this context, “about” may constitute a range above or below the reference wt. % value (e.g., plus or minus≤0.25 wt. %). In some embodiments, a degradable rubber composition may comprise about 0.8 parts per hundred rubber (Phr) of at least one polymerization accelerant, or about 1.0 Phr of at least one polymerization accelerant, or about 1.2 Phr of at least one polymerization accelerant, or about 1.4 Phr of at least one polymerization accelerant, or about 1.6 Phr of at least one polymerization accelerant, or about 1.8 Phr of at least one polymerization accelerant, or about 2.0 Phr of at least one polymerization accelerant, or about 2.2 Phr of at least one polymerization accelerant, or about 2.4 Phr of at least one polymerization accelerant, or about 2.6 Phr of at least one polymerization accelerant, or about 2.8 Phr of at least one polymerization accelerant, or about 3.0 Phr of at least one polymerization accelerant, or about 3.5 Phr of at least one polymerization accelerant, or about 4.0 Phr of at least one polymerization accelerant. In this context, “about” may constitute a range above or below the reference Phr value (e.g., plus or minus≤0.25 Phr).

According to some embodiments, a degradable rubber composition and/or cured packer may comprise a tackifier (e.g., Struktol Koresin) content of about 0.1 wt. %, of about 0.2 wt. %, or of about 0.3 wt. %, or of about 0.4 wt. %, or of about 0.5 wt. %, or of about 0.6 wt. %, or of about 0.7 wt. %, or of about 0.8 wt. %, or of about 0.9 wt. %, or of about 1.0 wt. %, or of about 1.25 wt. %, or of about 1.5 wt. % of the degradable rubber composition and/or cured packer. In this context, “about” may constitute a range above or below the reference wt. % value (e.g., plus or minus≤0.25 wt. %).

According to some embodiments, a degradable rubber composition and/or cured packer may comprise a silica (e.g., Hisil 190G-Silica) content of about 1 wt. %, of about 2 wt. %, or of about 3 wt. %, or of about 4 wt. %, or of about 5 wt. %, or of about 7 wt. %, or of about 10 wt. %, or of about 12 wt. %, or of about 15 wt. %, or of about 17 wt. %, or of about 20 wt. %, or of about 25 wt. % of the degradable rubber composition and/or cured packer. In this context, “about” may constitute a range above or below the reference wt. % value (e.g., plus or minus≤2 wt. %).

According to some embodiments, a degradable rubber composition and/or cured packer may comprise a 2,2,4-Trimethyl-1,2-dihydroquinoline (e.g., Stangard TM Q) content of about 0.1 wt. %, of about 0.2 wt. %, or of about 0.3 wt. %, or of about 0.4 wt. %, or of about 0.5 wt. %, or of about 0.6 wt. %, or of about 0.7 wt. %, or of about 0.8 wt. %, or of about 0.9 wt. %, or of about 1.0 wt. %, or of about 1.25 wt. %, or of about 1.5 wt. % of the degradable rubber composition and/or cured packer. In this context, “about” may constitute a range above or below the reference wt. % value (e.g., plus or minus≤0.25 wt. %).

According to some embodiments, a degradable rubber composition and/or cured packer may comprise a N-(1,3-Dimethylbutyl)-N′-phenyl-phenylenediamine (e.g., Santoflex 6PPD) content of about 0.1 wt. %, of about 0.2 wt. %, or of about 0.3 wt. %, or of about 0.4 wt. %, or of about 0.5 wt. %, or of about 0.6 wt. %, or of about 0.7 wt. %, or of about 0.8 wt. %, or of about 0.9 wt. %, or of about 1.0 wt. %, or of about 1.25 wt. %, or of about 1.5 wt. % of the degradable rubber composition and/or cured packer. In this context, “about” may constitute a range above or below the reference wt. % value (e.g., plus or minus≤0.25 wt. %).

In some embodiments, a degradable rubber composition and/or cured packer may comprise a water soluble resin, which may increase a swelling rate and a degree of swell of the elastomer. Exemplary water soluble resins that may be used comprise polyethylene oxide, carboxymethyl cellulose, polyvinyl pyrrolidone, hydroxyethyl cellulose, hydroxypropyl cellulose or combinations thereof.

In some embodiments, a degradable rubber composition may include a curing agent and/or curing system. Non-limiting examples are sulfur-based curing agents or peroxide curing agents. In some embodiments, co-agents may also be included in a degradable rubber composition. A curing system may be selected to be suitable with polymers used in a degradable rubber composition.

According to some embodiments, a degradable rubber composition and/or cured packer may comprise a thiuram disulfide (e.g., TMTD, Vulkacit Thiuram, Tuex) content of about 0.1 wt. %, of about 0.2 wt. %, or of about 0.3 wt. %, or of about 0.4 wt. %, or of about 0.5 wt. %, or of about 0.6 wt. %, or of about 0.7 wt. %, or of about 0.8 wt. %, or of about 0.9 wt. %, or of about 1.0 wt. %, or of about 1.25 wt. %, or of about 1.5 wt. % of the degradable rubber composition and/or cured packer. In this context, “about” may constitute a range above or below the reference wt. % value (e.g., plus or minus≤0.2 wt. %). In some embodiments, a thiuram disulfide may function as a polymerization accelerant.

According to some embodiments, a degradable rubber composition and/or cured packer may comprise at least one sulfur curing agent (e.g., Sulfur RM) at a content of about 0.8 wt. %, of about 1.0 wt. %, or of about 1.2 wt. %, or of about 1.4 wt. %, or of about 1.6 wt. %, or of about 1.8 wt. %, or of about 2.0 wt. %, or of about 2.2 wt. %, or of about 2.4 wt. %, or of about 2.6 wt. %, or of about 2.8 wt. %, or of about 3.0 wt. % of the degradable rubber composition and/or cured packer. In this context, “about” may constitute a range above or below the reference wt. % value (e.g., plus or minus≤0.25 wt. %). In some embodiments, a degradable rubber composition may comprise about 0.8 parts per hundred rubber (Phr) of at least one sulfur curing agent, or about 1.0 Phr of at least one sulfur curing agent, or about 1.2 Phr of at least one sulfur curing agent, or about 1.4 Phr of at least one sulfur curing agent, or about 1.6 Phr of at least one sulfur curing agent, or about 1.8 Phr of at least one sulfur curing agent, or about 2.0 Phr of at least one sulfur curing agent, or about 2.2 Phr of at least one sulfur curing agent, or about 2.4 Phr of at least one sulfur curing agent, or about 2.6 Phr of at least one sulfur curing agent, or about 2.8 Phr of at least one sulfur curing agent, or about 3.0 Phr of at least one sulfur curing agent, or about 3.5 Phr of at least one sulfur curing agent, or about 4.0 Phr of at least one sulfur curing agent. In this context, “about” may constitute a range above or below the reference Phr value (e.g., plus or minus≤0.2 Phr).

According to some embodiments, a degradable rubber composition and/or cured packer may comprise a peroxide (e.g., Dicup 40KE Peroxide, hydrogen peroxide, 40% Dicumyl Peroxide) content of about 0.1 wt. %, of about 0.2 wt. %, or of about 0.3 wt. %, or of about 0.4 wt. %, or of about 0.5 wt. %, or of about 0.6 wt. %, or of about 0.7 wt. %, or of about 0.8 wt. %, or of about 0.9 wt. %, or of about 1.0 wt. %, or of about 1.25 wt. %, or of about 1.5 wt. % of the degradable rubber composition and/or cured packer. In this context, “about” may constitute a range above or below the reference wt. % value (e.g., plus or minus≤0.1 wt. %).

According to some embodiments, a degradable rubber composition and/or cured packer may comprise a cyclohexylthiophthalimide (e.g., Sulfur RM) content of about 0.01 wt. %, of about 0.02 wt. %, or of about 0.03 wt. %, or of about 0.04 wt. %, or of about 0.05 wt. %, or of about 0.06 wt. %, or of about 0.07 wt. %, or of about 0.08 wt. %, or of about 0.09 wt. %, or of about 0.1 wt. %, or of about 0.125 wt. %, or of about 0.15 wt. % of the degradable rubber composition and/or cured packer. In this context, “about” may constitute a range above or below the reference wt. % value (e.g., plus or minus≤0.01 wt. %).

The present disclosure is directed, at least in part, to a use of at least one powder grade of super absorbent particles (SAP) that may be incorporated into degradable rubber compositions at higher concentrations. In some embodiments, at least one powder grade SAP may be incorporated into a degradable composition without detriment to the processability and/or the quality of an elastomer rubber composition used for producing the degradable composition and/or degradable swellable packers, both before and after curing occurs. Certain embodiments are directed to a use of powder SAPs; however, in other embodiments, granular and powder SAPs may be used in combination. The present disclosure contemplates that granular and powder grades may be combined in degradable compositions disclosed herein including degradable swellable packers disclosed herein. It has been unexpectedly found that increased loading of powder SAPs may be achieved (as compared to loading with granular SAPs) without degrading, or substantially degrading, the desired physical properties of the elastomer rubber composition, the cured packers and/or the cured packer after swelling. Some exemplary embodiments disclosed herein are directed to certain degradable rubber compositions, and other embodiments are directed to using powder grade SAPs in degradable swellable packers that may have other types of rubber based elastomeric compositions.

A degradable rubber composition may contribute to a high volume swell at high temperatures and/or high pressures, which characterizes the degradable rubber compositions, according to certain embodiments. A degradable rubber composition, according to some embodiments, may include SAPs, as well as other degradable swellable organic or inorganic materials. In some embodiments, an SAP may comprise partially neutralized polyacrylic acid sodium salts, crosslinked isoprene-maleic acid salts, starch-polyacrylic acid salts, crosslinked carboxylmethyl celluloses (CMC), polyvinyl alcohol-acrylic acid salts, and combinations thereof. Swellable organic acid salts comprise sodium acetate, sodium formate, sodium acrylate, and combinations thereof. Swellable inorganic materials comprise carbonates of sodium, potassium, lithium, calcium, magnesium, and combinations thereof. A sodium carbonate may be used in a form of soda ash instead of pure sodium carbonate. A degradable rubber composition may comprise a single degradable non-elastomeric material or a mixture of two or more degradable non-elastomeric material. Other non-limiting examples of degradable non-elastomeric material comprise polyacrylic acid, polymethacrylic acid, polyacrylamide, polyethyleneoxide, polyethylene glycol, polypropylene oxide, poly (acrylic acid-co-acrylamide), polymers made from zwitterionic monomers, which include N, N-dimethyl-N-acryloyloxyethyl-N-(3-sulfopropyl)-ammonium betaine, N, N-dimethyl-N-acrylamidopropyl-N-(2-carboxymethyl)-ammonium betaine, N, N-dimethyl-N-acrylamidopropyl-N-(3-sulfopropyl)-ammonium betaine, 2-(methylthio)ethyl methacryloyl-S-(sulfopropyl)-sulfonium betaine, 2-[(2-acryloylethyl)dimethylammonio]ethyl 2-methyl phosphate, [(2-acryloylethyl)dimethylammonio] methyl phosphonic acid, 2-(acryloyloxyethyl)-2′-(trimethylammonium)ethyl phosphate, 2-methacryloyloxy ethyl phosphorylcholine, 2-[(3-acrylamidopropyl)dimethylammonio]ethyl 2′-isopropyl phosphate, 1-vinyl-3-(3-sulfopropyl)imidazolium hydroxide, (2-acryloxyethyl)carboxymethyl methylsulfonium chloride, 1-(3-sulfopropyl)-2-vinylpyridinium betaine, N-(4-sulfobutyl)-N-methyl-N,N-diallylamine ammonium betaine, N,N-diallyl-N-methyl-N-(2-sulfoethyl)ammonium betaine or the like. According to some embodiments, a degradable non-elastomeric material may comprise poly-electrolytes, polyacyrlates (e.g., sodium polyacrylate), polyacryamide-co-polyacrylates (e.g., polyacryamide-co-potassium acrylate), polyacrylamides (e.g., potassium polyacrylamide), acrylic acids, hydrophilic clays, bentonite (e.g., sodium bentonite, potassium bentonite, calcium bentonite, or Wyoming bentonite), wood, cork, and/or cellulose fibers.

According to some embodiments, a degradable rubber composition and/or cured packer may comprise a sodium polyacrylate cross linked with acrylamide (e.g., Aquasorb 3006-63) content of about 35 wt. %, or of about 40 wt. %, or of about 45 wt. %, or of about 50 wt. %, or of about 55 wt. %, or of about 60 wt. %, or of about 65 wt. %, or of about 70 wt. %, or of about 75 wt. %, or of about 80 wt. %, or of about 85 wt. %, or of about 90 wt. % of the degradable rubber composition and/or cured packer. In this context, “about” may constitute a range above or below the reference wt. % value (e.g., plus or minus≤10 wt. %).

According to some embodiments, a degradable rubber composition and/or cured packer may comprise a stearic acid content of about 0.1 wt. %, of about 0.2 wt. %, or of about 0.3 wt. %, or of about 0.4 wt. %, or of about 0.5 wt. %, or of about 0.6 wt. %, or of about 0.7 wt. %, or of about 0.8 wt. %, or of about 0.9 wt. %, or of about 1.0 wt. %, or of about 1.25 wt. %, or of about 1.5 wt. % of the degradable rubber composition and/or cured packer. In this context, “about” may constitute a range above or below the reference wt. % value (e.g., plus or minus≤0.1 wt. %). In some embodiments, a degradable rubber composition may comprise about 0.1 parts per hundred rubber (Phr) of at least one stearic acid, or about 0.2 Phr of at least one stearic acid, or about 0.3 Phr of at least one stearic acid, or about 0.4 Phr of at least one stearic acid, or about 0.5 Phr of at least one stearic acid, or about 0.6 Phr of at least one stearic acid, or about 0.7 Phr of at least one stearic acid, or about 0.8 Phr of at least one stearic acid, or about 0.9 Phr of at least one stearic acid, or about 1.0 Phr of at least one stearic acid, or about 1.1 Phr of at least one stearic acid, or about 1.1 Phr of at least one stearic acid, or about 1.2 Phr of at least one stearic acid, or about 1.5 Phr of at least one stearic acid. In this context, “about” may constitute a range above or below the reference Phr value (e.g., plus or minus≤0.2 Phr).

In some embodiments, a degradable rubber composition may comprise silica (or other filler particles) to reinforce the rubber compound. In certain embodiments, silica may be fumed silica.

In some embodiments, a degradable rubber composition may comprise a salt, such as particles or fine particles of salt, which are incorporated into the degradable rubber to, for example, may allow migration of an aqueous composition (e.g. water, water-based fluids, salt-containing water-based fluids, and/or water formations, such as brines) into the degradable rubber (e.g., by osmosis) so as to introduce swelling of the degradable rubber upon such migration. Examples of salt may comprise one or more of the following metal containing salts, such as metal chlorides (e.g., sodium chloride, potassium chloride, or calcium chloride), metal phosphates (e.g., Ca₃(PO₄)₂), metal carbonates (e.g., CaCO₃ or BaCO₃), metal oxides (e.g., MgO), metal sulfides (e.g., ZnS), metal hydroxides (e.g., Fe(OH)₂), metal sulfates (e.g., BaSO₄), metal acetates, metal bicarbonates, metal formates, metal hydrosulphides, metal imides, metal nitrates, metal nitrides, dissociating salts, and non-metal salts (e.g., NH₄Cl).

In some embodiments, a degradable rubber composition may comprise a general purpose plasticizer for rubber products, such as phthalate esters (e.g., dioctyl phthalate), trimellitates, sebacates, adipates, terephthalates, benzoates, dibenzoates, organophosphates, gluterates or azelates.

According to some embodiments, a degradable rubber composition and/or cured packer may comprise a dioctyl phthalate (e.g., DOP) content of about 0.5 wt. %, of about 1 wt. %, or of about 2 wt. %, or of about 3 wt. %, or of about 4 wt. %, or of about 5 wt. %, or of about 6 wt. %, or of about 7 wt. %, or of about 8 wt. %, or of about 9 wt. %, or of about 10 wt. %, or of about 15 wt. % of the degradable rubber composition and/or cured packer. In this context, “about” may constitute a range above or below the reference wt. % value (e.g., plus or minus≤0.25 wt. %).

In some embodiments, a degradable rubber composition may comprise a material to reinforce a rubber compound to improve physical properties and/or color the product. Materials to reinforce a rubber compound may include, for example, pigments and/or carbon black (e.g., N-550, N326). According to some embodiments, a degradable rubber composition and/or cured packer may comprise a carbon black (e.g., Carbon black N234 ISAF HS, N326 Black) content of about 1 wt. %, of about 3 wt. %, or of about 5 wt. %, or of about 7 wt. %, or of about 9 wt. %, or of about 11 wt. %, or of about 13 wt. %, or of about 15 wt. %, or of about 17 wt. %, or of about 19 wt. %, or of about 21 wt. %, or of about 23 wt. %, or of about 25 wt. % of the degradable rubber composition and/or cured packer. In this context, “about” may constitute a range above or below the reference wt. % value (e.g., plus or minus≤1 wt. %). In some embodiments, a degradable rubber composition may comprise about 4 parts per hundred rubber (Phr) of at least one carbon black, or about 6 Phr of at least one carbon black, or about 8 Phr of at least one carbon black, or about 10 Phr of at least one carbon black, or about 12 Phr of at least one carbon black, or about 14 Phr of at least one carbon black, or about 16 Phr of at least one carbon black, or about 18 Phr of at least one carbon black, or about 20 Phr of at least one carbon black, or about 22 Phr of at least one carbon black, or about 24 Phr of at least one carbon black, or about 26 Phr of at least one carbon black, or about 28 Phr of at least one carbon black, or about 30 Phr of at least one carbon black. In this context, “about” may constitute a range above or below the reference Phr value (e.g., plus or minus≤4 Phr).

In some embodiments, a degradable rubber composition may comprise a material that may react with a filler particles and acts as an activator in a cure system, such as zinc oxide. Together with the zinc oxide, a rubber may further comprise stearic acid, which may react to produce a zinc stearate—an intermediate in the vulcanization mechanism.

In some embodiments, a degradable rubber composition may comprise a water-soluble, waxy solid (e.g., polyethylene glycol), which may be used as a process aid and/or lubricant during a rubber mixing process.

In some embodiments, a degradable rubber composition may comprise about 100 parts per hundred rubber (Phr) (i.e., the compositions comprise about 100 parts of an elastomer or combinations of elastomers) of an elastomer, about 40 Phr of polyethylene oxide, about 20 Phr of ionic peroxide cure and/or peroxide curing with a co-agent, about 126 Phr of a salt, and about 65 Phr of an SAP, clay, and/or other swelling material. In some embodiments, a degradable rubber composition may further comprise any combination of one or more of: about 35 Phr of a cement or Portland cement, about 30 Phr of silica, about 10 Phr of dioctyl phthalate, about 8 Phr of N-550 (carbon black), about 5 Phr of zinc oxide, about 1 Phr of stearic acid, and/or about 10 Phr of PEG6000 (polyethylene glycol).

According to some embodiments, a degradable rubber composition and/or cured packer may comprise a zinc oxide content of about 0.5 wt. %, of about 1 wt. %, or of about 2 wt. %, or of about 3 wt. %, or of about 4 wt. %, or of about 5 wt. %, or of about 6 wt. %, or of about 7 wt. %, or of about 8 wt. %, or of about 9 wt. %, or of about 10 wt. %, or of about 15 wt. % of the degradable rubber composition and/or cured packer and/or cured packer.

In some embodiments, a degradable rubber composition as described herein may be configured to swell by at least about 50%, or about 60%, or about 70%, or about 80%, or about 90%, or about 100%, or about 110%, or about 120%, or about 130%, or about 140%, or about 150%, or about 160%, or about 170%, or about 180%, or about 190%, or about 200%, or about 210%, or about 220%, or about 230%, or about 240%, or about 250% in brine solution, for example, an about 3 to about 30% brine solution, such as about 5%, or about 10%, or about 15%, or about 20%, or about 25%, or about 30% brine. A brine solution may comprise water with dissolved alkali metal salts (e.g., NaCl or KCl) and/or alkaline-earth metal salts (e.g., CaCl₂, CaCO₃, or MgCl₂). In some embodiments, a degradable rubber composition as described herein may be configured to swell by at least the same or similar amounts in oil- or hydrocarbon-based fluids.

In some embodiments, a degradable rubber composition may comprise the composition shown in Table 1 (Composition A):

TABLE 1
Composition of Degradable Composition A

| Material Description | Parts Per Hundred (Phr) | |
|---|---|---|
| Natural Rubber (e.g., Polyisoprene, SVR10) | 5-45 | (e.g., 30) |
| Polyurethane (e.g., Millethane 76) | 30-100 | (e.g., 70) |
| Carbon Black (e.g., N326) | 5-30 | (e.g., 45) |
| Zinc Stearate | .1-2 | (e.g., 0.7) |
| Tetrabenzyl thiuram disulfide (e.g., TBzTD) | 0.1-6 | (e.g., 0.45) |
| ZnCl + MBTS (e.g., Thanecure ZM) | 0.1-2 | (e.g., 0.4) |
| Sulfur | 0.5-4 | (e.g., 2.35) |
| Mercaptobenzothiazole disulfide (e.g., MBTS) | 1-5 | (e.g., 3.3) |
| Stearic Acid | 0.1-3 | (e.g., 0.3) |

In some embodiments, a degradable rubber composition may comprise the composition shown in Table 2 (Composition B):

TABLE 2
Composition of Degradable Composition B

| Material Description | Parts Per Hundred (Phr) | |
|---|---|---|
| Natural Rubber (e.g., Polyisoprene, SVR10) | 5-45 | (e.g., 30) |
| Polyurethane (e.g., Millethane 76) | 30-100 | (e.g., 70) |
| Fumed Silica (e.g., HISIL 190G) | 40-50 | (e.g., 40) |
| Carbon Black (e.g., N234) | 5-30 | (e.g., 25) |
| Dioctyl Phthalate (DOP) | 3-9 | (e.g., 6) |
| ZnCl + MBTS (e.g., Thanecure ZM) | 0.1-2 | (e.g., 0.35) |
| Antiozonant (e.g., 6PPD) | 0.5-2 | (e.g., 1) |
| Antidegradant (e.g., TMQ) | 0.5-2.5 | (e.g., 1.5) |
| Tackifier (e.g., KORESIN BASF) | 1-5 | (e.g., 3) |
| Sulfur | 0.5-4 | (e.g., 2) |
| Tetramethylthiuram disulfide (TMTD) | 1-3 | (e.g., 2) |
| Inhibitor (e.g., PVI, Akrochem CTP or retarder | 0.3-0.7 | (e.g., 0.5) |
| CTP) | | |
| Stearic Acid | 0.1-3 | (e.g., 1) |

In some embodiments, a degradable rubber composition may comprise the composition shown in Table 3 (Composition C):

TABLE 3
Composition of Degradable Composition C

| Material Description | Parts Per Hundred (Phr) | |
|---|---|---|
| Natural Rubber (e.g., Polyisoprene, SVR10) | 5-45 | (e.g., 30) |
| Polyurethane (e.g., Millethane 76) | 30-100 | (e.g., 70) |
| Carbon Black (e.g., N326) | 5-30 | (e.g., 20) |
| Zinc Stearate | .1-2 | (e.g., 0.7) |
| Tetrabenzyl thiuram disulfide (e.g., TBzTD) | 0.1-6 | (e.g., 0.35) |
| ZnCl + MBTS (e.g., Thanecure ZM) | 0.1-2 | (e.g., 0.35) |
| Sulfur | 0.5-4 | (e.g., 2) |
| Mercaptobenzothiazole disulfide (e.g., MBTS) | 1-5 | (e.g., 3.3) |
| Stearic Acid | 0.1-3 | (e.g., 1) |

In some embodiments, a degradable rubber composition may comprise the composition shown in Table 4 (Composition D):

TABLE 4
Composition of Degradable Composition D

| Material Description | Parts Per Hundred (Phr) | |
|---|---|---|
| Natural Rubber (e.g., Polyisoprene, SVR10) | 5-45 | (e.g., 40) |
| Polyurethane (e.g., Millethane 76) | 30-100 | (e.g., 100) |
| Carbon Black (e.g., N326) | 5-30 | (e.g., 30) |
| Zinc Stearate | .1-2 | (e.g., 2) |
| Antiozonant (e.g., 6PPD) | 0-2 | (e.g., 2) |
| Antidegradant (e.g., TMQ) | 0-2.5 | (e.g., 2.5) |
| Tetrabenzyl thiuram disulfide (e.g., TBzTD) | 0.1-6 | (e.g., 0.5) |
| ZnCl + MBTS (e.g., Thanecure ZM) | 0.1-2 | (e.g., 2) |
| Sulfur | 0.5-4 | (e.g., 3) |
| Mercaptobenzothiazole disulfide (e.g., MBTS) | 1-5 | (e.g., 5) |
| Inhibitor (e.g., PVI, Akrochem CTP or retarder | 0-0.7 | (e.g., 0.7) |
| CTP) | | |
| Stearic Acid | 0.1-3 | (e.g., 2) |

In some embodiments, a degradable rubber composition may comprise the composition shown in Table 5 (Composition E):

TABLE 5
Composition of Degradable Composition E

| Material Description | Parts Per Hundred (Phr) | |
|---|---|---|
| Natural Rubber (e.g., Polyisoprene, SVR10) | 5-45 | (e.g., 25) |
| Polyurethane (e.g., Millethane 76) | 30-100 | (e.g., 60) |
| Carbon Black (e.g., N326) | 5-30 | (e.g., 15) |
| Zinc Stearate | .1-2 | (e.g., 0.5) |
| Antiozonant (e.g., 6 PPD) | 0-2 | (e.g., 1.5) |
| Antidegradant (e.g., TMQ) | 0-2.5 | (e.g., 1.1) |
| Tetrabenzyl thiuram disulfide (e.g., TBzTD) | 0.1-6 | (e.g., 0.25) |
| ZnCl + MBTS (e.g., Thanecure ZM) | 0.1-2 | (e.g., 0.15) |
| Sulfur | 0.5-4 | (e.g., 1) |
| Mercaptobenzothiazole disulfide (e.g., MBTS) | 1-5 | (e.g., 2.1) |
| Inhibitor (e.g., PVI, Akrochem CTP or retarder | 0-0.7 | (e.g., 0.1) |
| CTP) | | |
| Stearic Acid | 0.1-3 | (e.g., .75) |

In some embodiments, a degradable rubber composition may comprise the composition in Table 6 (Composition F):

TABLE 6
Composition of Degradable Composition F

| Material Description | Parts Per Hundred (Phr) | |
|---|---|---|
| Natural Rubber (e.g., Polyisoprene) | 5-45 | (e.g., 30) |
| Polyurethane (e.g., Millethane 76) | 30-100 | (e.g., 75) |
| Carbon Black (e.g., N326) | 5-30 | (e.g., 25) |
| Zinc Stearate | .1-2 | (e.g., 0.9) |
| Antiozonant (e.g., 6PPD) | 0-2 | (e.g., 1.5) |
| Antidegradant (e.g., TMQ) | 0-2.5 | (e.g., 1.9) |
| Tetrabenzyl thiuram disulfide (e.g., TBzTD) | 0.1-6 | (e.g., 0.3) |
| ZnCl + MBTS (e.g., Thanecure ZM) | 0.1-2 | (e.g., 0.3) |
| Sulfur | 0.5-4 | (e.g., 3) |
| Mercaptobenzothiazole disulfide (e.g., MBTS) | 1-5 | (e.g. 4) |
| Inhibitor (e.g., PVI, Akrochem CTP or retarder | 0-0.7 | (e.g., 0.6) |
| CTP) | | |
| Stearic Acid | 0.1-3 | (e.g., 2) |

In some embodiments, a degradable rubber composition may comprise the composition shown in Table 7 (Composition G):

TABLE 7
Composition of Degradable Composition G

| Material Description | Parts Per Hundred (Phr) | |
|---|---|---|
| Natural Rubber (e.g., Polyisoprene) | 5-45 | (e.g., 43) |
| Polyurethane (e.g., Millethane 76) | 30-100 | (e.g., 95) |
| Carbon Black (e.g., N326) | 5-30 | (e.g., 10) |
| Zinc Stearate | .1-2 | (e.g., 0.9) |
| Antiozonant (e.g., 6PPD) | 0-2 | (e.g., 0.8) |
| Antidegradant (e.g., TMQ) | 0-2.5 | (e.g., 2.1) |
| Tetrabenzyl thiuram disulfide (e.g., TBzTD) | 0.1-6 | (e.g., 4.5) |
| ZnCl + MBTS (e.g., Thanecure ZM) | 0.1-2 | (e.g., 0.8) |
| Sulfur | 0.5-4 | (e.g., 1.6) |
| Mercaptobenzothiazole disulfide (e.g., MBTS) | 1-5 | (e.g. 4) |
| Inhibitor (e.g., PVI, Akrochem CTP or retarder | 0-0.7 | (e.g., 0.7) |
| CTP) | | |
| Stearic Acid | 0.1-3 | (e.g., 2.6) |

In some embodiments, a degradable rubber composition may comprise the composition shown in Table 8 (Composition H):

TABLE 8
Composition of Degradable Composition H

| Material Description | Parts Per Hundred (Phr) | |
|---|---|---|
| Natural Rubber (e.g., Polyisoprene) | 5-45 | (e.g., 20) |
| Polyurethane (e.g., Millethane 76) | 30-100 | (e.g., 85) |
| Carbon Black (e.g., N326) | 5-30 | (e.g., 20) |
| Zinc Stearate | .1-2 | (e.g., 0.4) |
| Antiozonant (e.g., 6PPD) | 0-2 | (e.g., 1.1) |
| Antidegradant (e.g., TMQ) | 0-2.5 | (e.g., 1.4) |
| Tetrabenzyl thiuram disulfide (e.g., TBzTD) | 0.1-6 | (e.g., 0.3) |
| ZnCl + MBTS (e.g., Thanecure ZM) | 0.1-2 | (e.g., 0.8) |
| Sulfur | 0.5-4 | (e.g., 4) |
| Mercaptobenzothiazole disulfide (e.g., MBTS) | 1-5 | (e.g. 3) |
| Inhibitor (e.g., PVI, Akrochem CTP or retarder | 0-0.7 | (e.g., 0.4) |
| CTP) | | |
| Stearic Acid | 0.1-3 | (e.g., 2) |

In some embodiments, a degradable rubber composition may comprise the composition shown in Table 9 (Composition I):

TABLE 9
Composition of Degradable Composition I

| Material Description | Parts Per Hundred (Phr) | |
|---|---|---|
| Natural Rubber (e.g., Polyisoprene) | 5-45 | (e.g., 40) |
| Polyurethane (e.g., Millethane 76) | 30-100 | (e.g., 80) |
| Carbon Black (e.g., N326) | 5-30 | (e.g., 30) |
| Zinc Stearate | .1-2 | (e.g., 1.5) |
| Antiozonant (e.g., 6PPD) | 0-2 | (e.g., 1.4) |
| Antidegradant (e.g., TMQ) | 0-2.5 | (e.g., 1) |
| Tetrabenzyl thiuram disulfide (e.g., TBzTD) | 0.1-6 | (e.g., 0.5) |
| ZnCl + MBTS (e.g., Thanecure ZM) | 0.1-2 | (e.g., 0.1) |
| Sulfur | 0.5-4 | (e.g., 4) |
| Mercaptobenzothiazole disulfide (e.g., MBTS) | 1-5 | (e.g. 2) |
| Inhibitor (e.g., PVI, Akrochem CTP or retarder | 0-0.7 | (e.g., 0.8) |
| CTP) | | |
| Stearic Acid | 0.1-3 | (e.g., 2) |

In some embodiments, a degradable rubber composition may comprise the composition shown in Table 10 (Composition J):

TABLE 10
Composition of Degradable Composition J

| Material Description | Parts Per Hundred (Phr) | |
|---|---|---|
| Natural Rubber (e.g., Polyisoprene) | 5-45 | (e.g., 30) |
| Polyurethane (e.g., Millethane 76) | 30-100 | (e.g., 70) |
| Carbon Black (e.g., N326) | 5-30 | (e.g., 45) |
| Zinc Stearate | .1-2 | (e.g., 0.7) |
| Antiozonant (e.g., 6PPD) | 0-2 | (e.g., 1.5) |
| Antidegradant (e.g., TMQ) | 0-2.5 | (e.g., 2) |
| Tetrabenzyl thiuram disulfide (e.g., TBzTD) | 0.1-6 | (e.g., 0.45) |
| ZnCl + MBTS (e.g., Thanecure ZM) | 0.1-2 | (e.g., 0.4) |
| Sulfur | 0.5-4 | (e.g., 2.35) |
| Mercaptobenzothiazole disulfide (e.g., MBTS) | 1-5 | (e.g. 3.3) |
| Inhibitor (e.g., PVI, Akrochem CTP or retarder | 0-0.7 | (e.g., 0.2) |
| CTP) | | |
| Stearic Acid | 0.1-3 | (e.g., 0.3) |

In some embodiments, a degradable rubber composition may comprise the composition shown in Table 11 (Composition K):

TABLE 11
Composition of Degradable Composition K

| Material Description | Parts Per Hundred (Phr) | |
|---|---|---|
| Natural Rubber (e.g., Polyisoprene, SVR10) | 5-45 | (e.g., 45) |
| Polyurethane (e.g., Millethane 76) | 30-100 | (e.g., 45) |
| Carbon Black (e.g., N326) | 5-30 | (e.g., 25) |
| Zinc Stearate | .1-2 | (e.g., 0.7) |
| Antiozonant (e.g., 6PPD) | 0-2 | (e.g., 1) |
| Antidegradant (e.g., TMQ) | 0-2.5 | (e.g., 1.5) |
| Tetrabenzyl thiuram disulfide (e.g., TBzTD) | 0.1-6 | (e.g., 0.35) |
| ZnCl + MBTS (e.g., Thanecure ZM) | 0.1-2 | (e.g., 0.35) |
| Sulfur | 0.5-4 | (e.g., 2) |
| Mercaptobenzothiazole disulfide (e.g., MBTS) | 1-5 | (e.g., 3.3) |
| Inhibitor (e.g., PVI, Akrochem CTP or retarder | 0-0.7 | (e.g., 0.5) |
| CTP) | | |
| Stearic Acid | 0.1-3 | (e.g., 1) |

In some embodiments, a degradable rubber composition may comprise the composition shown in Table 12 (Composition L):

TABLE 12
Composition of Degradable Composition L

| Material Description | Parts Per Hundred (Phr) | |
|---|---|---|
| Natural Rubber (e.g., Polyisoprene, SVR10) | 5-45 | (e.g., 30) |
| Polyurethane (e.g., Millethane 76) | 30-100 | (e.g., 70) |
| Carbon Black (e.g., N326) | 5-30 | (e.g., 25) |
| Zinc Stearate | .1-2 | (e.g., 1.2) |
| Antiozonant (e.g., 6PPD) | 0-2 | (e.g., 1.5) |
| Antidegradant (e.g., TMQ) | 0-2.5 | (e.g., 2) |
| Tetrabenzyl thiuram disulfide (e.g., TBzTD) | 0.1-6 | (e.g., 4.5) |
| ZnCl + MBTS (e.g., Thanecure ZM) | 0.1-2 | (e.g., 0.5) |
| Sulfur | 0.5-4 | (e.g., 3) |
| Mercaptobenzothiazole disulfide (e.g., MBTS) | 1-5 | (e.g. 4) |
| Inhibitor (e.g., PVI, Akrochem CTP or retarder | 0-0.7 | (e.g., 0.2) |
| CTP) | | |
| Stearic Acid | 0.1-3 | (e.g., 2) |

In some embodiments, a degradable rubber composition, after curing, may have a Shore A hardness of, at least about 15, or at least about 20, or at least about 25, or at least about 30, or at least about 35, or at least about 40, or at least about 45, or at least about 50, or at least about 55, or at least about 60, or at least about 65, or at least about 70, or at least about 75, or at least about 80, or at least about 85, or at least about 90, or at least about 95, or at least about 100, or at least about 110, or at least about 115, or at least about 120. In some embodiments, a degradable rubber composition, after curing, may have a Shore B hardness of, at least about 15, or at least about 20, or at least about 25, or at least about 30, or at least about 35, or at least about 40, or at least about 45, or at least about 50, or at least about 55, or at least about 60, or at least about 65, or at least about 70, or at least about 75, or at least about 80, or at least about 85, or at least about 90, or at least about 95, or at least about 100, or at least about 110, or at least about 115, or at least about 120. In some embodiments, a degradable rubber composition, after curing, may have a Shore C hardness of, at least about 15, or at least about 20, or at least about 25, or at least about 30, or at least about 35, or at least about 40, or at least about 45, or at least about 50, or at least about 55, or at least about 60, or at least about 65, or at least about 70, or at least about 75, or at least about 80, or at least about 85, or at least about 90, or at least about 95, or at least about 100, or at least about 110, or at least about 115, or at least about 120. According to some embodiments, a composition of a degradable rubber composition may be formulated to have a desired Shore A, B, or C hardness. For example, concentrations of silica may be adjusted, which may increase or decrease a desired Shore A, B, or C hardness. In some embodiments, carbon black concentrations may be adjusted, which may increase or decrease a desired Shore A, B, or C hardness. A cure system which may be used to cure a degradable rubber composition may be adjusted, which may alter the Shore A, B, or C hardness. In some embodiments, reinforcing a filler and/or adjusting the density of cross-linking may result in an in crease or decrease of a desired Shore A, B, or C hardness.

According to some embodiments, degradable rubber compositions may advantageously be degradable when in contact with an aqueous composition. Embodiments of degradable rubber compositions described herein may advantageously reduce or remove the need for retrieving corresponding swellable packers that have been deployed in wellbores. Furthermore, embodiments of degradable rubber compositions described herein may advantageously reduce or prevent damage to the wellbore that may otherwise be associated with retrieving swellable packers from a wellbore.

In some embodiments, a degradable rubber compositions disclosed herein may comprise at least one polyurethane. In some embodiments, a polyurethane may comprise a polyether ether, a polyester ester, or combinations thereof. In some embodiments, a polyether ether may be acidic terminated. According to some embodiments, a polyester ester may be a hydrolytic molecule. A polyurethane, according to some embodiments, may be cured by peroxide, sulfur, or a combination thereof. In some embodiments, a polyurethane may be pliable, injectable, moldable, calenderable, or combinations thereof. In some embodiments, a degradable rubber composition may comprise a hydroquinone. Incorporation of at least one polyurethane in a degradable rubber composition may advantageously promote degradation upon contact with an aqueous composition.

According to some embodiments, a degradable rubber composition may comprise at least one antioxidant. In some embodiments, at least one antioxidant may comprise a hydroquinone (e.g., tert-butyl hydroquinone, hydroquinone), a phenylene diamine (e.g., N,N′-di-2-butyl-1,4-phenylenediamine), a polyphenol (e.g., 1,4-benzenediol). In some embodiments, an antioxidant may prevent oxidation of a degradable rubber composition.

In some embodiments, a degradable rubber composition may comprise a polyester oil. In some embodiments, a polyester oil may be blended with a natural rubber. According to some embodiments, blending a polyester oil with a natural rubber may accelerate curing.

According to some embodiments, a degradable rubber composition may comprise a haloid polymer. In some embodiments, a haloid polymer may comprise a polymer source (e.g., polyethylene terephthalate (PET)), a metal source (e.g., aluminum oxide), silica, or combinations thereof. A polymer source may comprise polyglycolide, polyactic acid, polycaprolactone, polyhydroxyalkanoate, polyhydroxybutyrate, polyethylene adipate, polybutylene succinate, polyethylene terephthalate, polybutylene terephthalate, polytrimethylene terephthalate, polyethylene naphthalate, vectran (polyester produced by the condensation of 4-hydroxybenzoic acid and 6-hydroxynapthalene-2-carboxylic acid), polystyrenes, polytetrafluoroethylenes, polyvinylhalides, nylons, polycaprolactams, polycaprolactones, polymers of caprolactam and adipate esters, polyadipates, polyurethanes, polyalkanes, polyacrylates, and copolymers thereof. A metal source may comprise titanium dioxide (TiO₂), aluminum oxide (Al₂O₃), calcium carbonate (CaCO₃), calcium sulfate (CaSO₄), silicon dioxide (SiO₂), boron nitride (BN), aluminum nitride (AlN), clay, zirconium oxide (ZrO₂), zinc oxide (ZnO₂), zinc sulfide (ZnS₂), barium sulfate (BaSO₄), and combinations thereof. In some embodiments, a degradable rubber comprising a haloid polymer may degrade from about 25% to about 90% within a period of time, the period of time selected from the group consisting of about 1 day, about 3 days, about 7 days, about 14 days, about 21 days, and about 28 days. According to some embodiments, a degradable rubber composition comprising a haloid polymer may degrade from about 25% to about 90% at a temperature, the temperature selected from the group consisting of about 50° F. (10° C.), about 75° F. (23.9° C.), about 100° F. (37.8° C.), about 125° F. (51.7° C.), about 150° F. (65.6° C.), about 175° F. (79.4° C.), about 200° F. (93.3° C.), about 225° F. (107.2° C.), about 250° F. (121.1° C.), about 275° F. (135° C.), and about 300° F. (148.9° C.). In some embodiments, a degradable rubber composition comprising a haloid polymer may degrade from about 25% to about 90% within about 14 days at about 120° F. (48.9° C.).

### Degradation of Degradable Rubber Composition

In some embodiments, a degradable rubber composition comprising a natural rubber and a polyurethane may be degradable. For example, a degradable rubber composition may be degradable in an aqueous composition. According to some embodiments, degradation of a degradable rubber composition comprises a change in physical and chemical properties of the degradable rubber composition. For example, physical and chemical properties of a degradable rubber composition may comprise tensile strength, mass, color, shape, elasticity, tactility, hardness, morphology, thermal properties, or combinations thereof. In some embodiments, thermal properties comprises glass transition temperature, heat capacity, thermal conductivity, thermal expansion, or combinations thereof. In some embodiments morphology may comprise crystallinity, molecular weight, cross-linking, or combinations thereof. According to some embodiments, degradation may comprise a change in at least one color. Degradation may also comprise leaching of at least a portion of at least one component of a degradable rubber composition into a surrounding environment of the degradable rubber composition.

In some embodiments, degradation may be induced by exogenous and endogenous factors. For example, degradation may be induced by at least one exogenous factor, the at least one exogenous factor comprising photo-induced degradation, thermal degradation, chemical degradation, shear stress, solvolysis, ozonolysis, physical abrasion, chemical oxidation, galvanic action, biological degradation, electrical current, cooling, or combinations thereof. In some embodiments, endogenous factors may comprise chemical instability, intramolecular energy, oxidation, average kinetic molecular energy, chemical reduction, or combinations thereof. For example, degradation due to hydrolysis may be affected by the ester structure of the polyester of the degradable rubber composition. A degradable rubber comprising polycaprolactams and adipate esters may readily hydrolyze due to a decreased activation energy of the adipate ester group. Additionally, an acid content of the degradable rubber may desirably permit and/or promote hydrolysis as the acid content increases in the end chain of the adipate ester. Other endogenous factors may influence degradation such as the intrinsic viscosity, which may be calculated from the molecular weight of the degradable rubber composition using the Mark-Houwink Equation.

In some embodiments, a degradable rubber composition may degrade in the presence of at least one solvent (e.g., an aqueous composition). A solvent may comprise or be selected from water, ethyl acetate, dichloromethane, hydrocarbons (e.g., hexanes), alcoholic solvents (e.g., methanol), ethereal solvents (e.g., diethyl ether), or combinations thereof. In some embodiments, an aqueous composition may comprise or be selected from water, water solutions, downhole water-based solutions, aqueous-based solutions, and/or brines. Some embodiments of the present disclosure swell in the presence of an aqueous composition (e.g., water, water solutions, downhole water-based solutions, aqueous-based solutions, brines, and/or oil- or hydrocarbon-based fluid). As used herein, the term “brine” is meant to refer to a water-based fluid containing alkaline or alkaline earth chlorides salt, such as sodium chloride, calcium chloride, sulphates and carbonates. Swelling characteristics may be variable in relation to a variability in salt concentration and/or temperature, among other things. That is, for examples, as the salt concentration increases, the amount of swelling may decrease. Numerical percentages for brines disclosed herein are percentages by volume unless otherwise stated.

Percent degradation of a degradable rubber composition may be assessed or expressed on any suitable basis (e.g., (w/w), (w/v), (v/v)). According to some embodiments, a degradable rubber composition may degrade at least about 10% over about 1 day, or at least about 20% over about 1 day, or at least about 30% over about 1 day, or at least about 40% over about 1 day, or at least about 50% over about 1 day, or at least about 10% over about 2 days, or at least about 20% over about 2 days, or at least about 30% over about 2 days, or at least about 40% over about 2 days, or at least about 50% over about 2 days, or at least about 10% over about 3 days, or at least about 20% over about 3 days, or at least about 30% over about 3 days, or at least about 40% over about 3 days, or at least about 50% over about 3 days, or at least about 10% over about 8 days, or at least about 20% over about 8 days, or at least about 30% over about 8 days, or at least about 40% over about 8 days, or at least about 50% over about 8 days, or at least about 10% over about 14 days, or at least about 20% over about 14 days, or at least about 30% over about 14 days, or at least about 40% over about 14 days, or at least about 50% over about 14 days, or at least about 10% over about 21 days, or at least about 20% over about 21 days, or at least about 30% over about 21 days, or at least about 40% over about 21 days, or at least about 50% over about 21 days, or at least about 75% over about 21 days, or at least about 90% over about 21 days, or at least about 10% over about 28 days, or at least about 20% over about 28 days, or at least about 30% over about 28 days, or at least about 40% over about 28 days, or at least about 50% over about 28 days, or at least about 75% over about 28 days, or at least about 90% over about 28 days. A degradable rubber composition may degrade from about 25% to about 90% within a period of time, the period of time selected from the group consisting of about 1 day, about 3 days, about 7 days, about 14 days, about 21 days, and about 28 days. A degradable rubber composition may degrade from about 25% to about 90% at a temperature, the temperature selected from the group consisting of about 50° F. (10° C.), about 75° F. (23.9° C.), about 100° F. (37.8° C.), about 125° F. (51.7° C.), about 150° F. (65.6° C.), about 175° F. (79.4° C.), about 200° F. (93.3° C.), about 225° F. (107.2° C.), about 250° F. (121.1° C.), about 275° F. (135° C.), and about 300° F. (148.9° C.). A degradable rubber composition may degrade from about 25% to about 90% within about 14 days at about 120° F. (48.9° C.).

According to some embodiments, degradation of a degradable rubber composition may be measured through differential scanning calorimetry (DSC). In some embodiments, a degradable rubber composition may be placed in a crystal chamber and then the temperature is increased to about 572° F. (300° C.), wherein a glass transition temperature (TG) may be measured. According to some embodiments, a TG value of a degraded degradable rubber composition may be compared to a TG value of a non-degraded degradable rubber composition. In some embodiments, a TG value of a degraded degradable rubber composition may be compared to a differentially degraded degradable rubber composition. In some embodiments, differential hydrolytic breakdown of a degradable rubber composition may be measured through DSC.

In some embodiments, a percent degradation of a degradable rubber composition may be expressed as

$$\frac{TG value of the composition under test}{TG value of a reference composition} \times 100 = Percent Degradation$$

where the composition under test is the composition (e.g., degradable rubber composition) that may have or has undergone some degradation and the reference composition is a composition having the same formulation as the composition under test, but that has not been subject to degradation.

### Swellable Packer Assemblies

According to some embodiments, degradable rubber compositions may be employed in swellable packer assemblies. In some embodiments, swellable packer assemblies may swell when exposed to solvents (e.g., water based fluids, alcohols, hydrocarbons, ethyl acetate, dichloromethane, dimethyl sulfoxide, dimethylformamide). When a swellable packer assembly swells, a region between a wellbore wall and the swellable packer assembly may be sealed, wherein the seal may be held at high pressures, according to some embodiments. In some embodiments, sealing a region between a wellbore wall and the swellable packer may at least in part prevent at least one gas and/or at least one fluid from permeating and/or passing the seal between the wellbore and the swellable packer assembly.

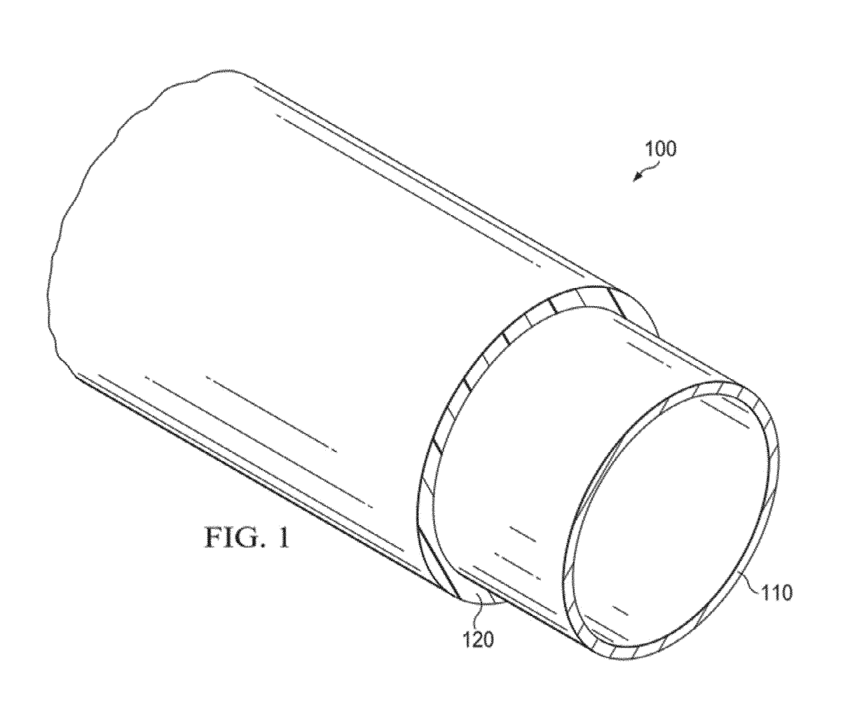

FIG. 1 illustrates an exemplary embodiment of a sectional view of a degradable swellable packer assembly comprising a degradable rubber composition, which is capable of swelling in the presence of aqueous compositions and/or aqueous composition formations, such as brines, and oil- or hydrocarbon-based fluids. As shown, a degradable swellable packer assembly 100 comprises a conduit 110 with a degradable rubber 120 wrapped around the conduit 110. In some embodiments, a conduit 110 may be made of a suitable metal. In some embodiments, a rubber 120 may be vulcanized to a conduit 110 such that the combination has a substantially unitary construction. In some embodiments, a degradable swellable packer assembly 100 may be designed to reduce and/or minimize extrusion of a rubber during use. In some embodiments, end rings (not shown) may be provided to protect the ends of a rubber 120, or, alternatively, the end portions of the rubber 120 may be tapered (not shown) to more easily move through a well to a desired depth. A degradable swellable packer 100 may be produced using a number of suitable techniques, the techniques comprising pressure molding, injection molding, extruding, calendar wrapping, strip winding, and combinations thereof.

According to some embodiments, a swellable packer assembly may comprise a conduit and at least one degradable rubber composition. In some embodiments, at least a portion of at least one degradable rubber composition may be wrapped around at least a portion of a conduit. At least one degradable rubber composition that may be wrapped around at least a portion of a conduit may be cured, according to some embodiments. Exemplary embodiments described herein may provide for at least one degradable packer described herein to cure after the at least one degradable rubber composition has been wrapped around at least a portion of a conduit.

In some embodiments, a swellable packer assembly may comprise a degradable rubber composition and a conduit, wherein the degradable rubber composition may be susceptible to being in contact with at least one solvent (e.g., aqueous composition based fluids, alcohols, hydrocarbons, ethyl acetate, dichloromethane, dimethyl sulfoxide, dimethylformamide). In some embodiments, a degradable rubber composition may degrade while being in contact with at least one solvent. A swellable packer assembly, may in part be degradable in an aqueous composition.

A swellable packer assembly comprising at least one degradable rubber composition may seal a wellbore hole at a pressure, the pressure comprising at least about 1,000 psi (6,894.76 kPa), or at least about 2,000 psi (13,790 kPa), or at least about 3,000 psi (20684 kPa), or at least about 4,000 psi (27,579 kPa), or at least about 5,000 psi (34,474 kPa), or at least about 6,000 psi (41,369 kPa), or at least about 7,000 psi (48,263 kPa), or at least about 8,000 psi (55,158 kPa), or at least about 9,000 psi (62,053 kPa), or at least about 10,000 psi (68,948 kPa), or at least about 11,000 psi (75,842 kPa), according to some embodiments. In this context, “about” may constitute a range above or below the reference pressure value (e.g., plus or minus≤1000 psi). In some embodiments, a swellable packer assembly comprising at least one degradable rubber composition, after curing, may be configured to swell while being subjected to a pressure of at least about 1,000 psi (6,894.76 kPa), or at least about 2,000 psi (13,790 kPa), or at least about 3,000 psi (20684 kPa), or at least about 4,000 psi (27,579 kPa), or at least about 5,000 psi (34,474 kPa), or at least about 6,000 psi (41,369 kPa), or at least about 7,000 psi (48,263 kPa), or at least about 8,000 psi (55,158 kPa), or at least about 9000 psi, or at least about 10,000 psi (68,948 kPa), or at least about 11,000 psi (75,842 kPa), according to some embodiments. In this context, “about” may constitute a range above or below the reference pressure value (e.g., plus or minus≤1,000 psi (6,894.76 kPa)). In some embodiments, a swellable packer assembly may withstand high pressures without substantial physical failures, such as tearing and/or perforation.

A swellable packer assembly comprising at least one degradable rubber composition may seal a wellbore hole while being exposed to a mixture of conditions comprising a temperature, the temperature comprising at least about 200° F. (93.3° C.), at least about 225° F. (107.2° C.), at least about 250° F. (121.1° C.), at least about 275° F. (135° C.), at least about 300° F. (148.9° C.), at least about 325° F. (162.8° C.), at least about 350° F. (176.7° C.), at least about 375° F. (190.6° C.), at least about 400° F. (204.4° C.), at least about 425° F. (218° C.), at least about 450° F. (232.2° C.), at least about 475° F. (246.1° C.), or at least about 500° F. (260° C.). In this context, “about” may constitute a range above or below the reference temperature (e.g., plus or minus≤50° F. (10° C.)).

In some embodiments, a swellable packer assembly comprising at least one degradable rubber composition may swell in the present of at least one solvent (e.g., water based fluids, alcohols, hydrocarbons, ethyl acetate, dichloromethane, dimethyl sulfoxide, dimethylformamide), wherein the swellable packer assembly swells by about 20% to about 250% by volume. In some embodiments, a swellable packer swells by about 20% to about 250% by volume, wherein the swelling occurs within a period of time, the period of time comprising about 0.5 days, or about 1 day, or about 2 days, or about 3 days, or about 4 days, or about 5 days, or about 6 days, or about 7 days, or about 14 days, or about 28 days, or about 35 days, or about 42 days, or about 48 days, or about 56 days. In this context, “about” may constitute a range above or below the reference time (e.g., plus or minus≤3 days).

It is understood that the listed apparatuses for each unit are for illustration purposes only, and this is not intended to limit the scope of the application. A specific combination of these or other apparatuses or units can be configured in such a system for the intended use based on the teachings in the application.

Persons skilled in the art may make various changes in the shape, size, number, separation characteristic, and/or arrangement of parts without departing from the scope of the instant disclosure. Persons skilled in the art may make various changes in the kind, number, and/or arrangement of R-groups, substituents, and/or heteroatoms without departing from the scope of the instant disclosure. The operability of compositions, systems, and methods of the disclosure is not contingent on a specific mechanism of action unless expressly stated to be so contingent. Where proposed or possible mechanisms of action are offered, it will be appreciated that such mechanisms are non-limiting and variations and/or combinations of such mechanisms may be operable. Each disclosed method and method step may be performed in association with any other disclosed method or method step and in any order according to some embodiments. Where the verb “may” appears, it is intended to convey an optional and/or permissive condition, but its use is not intended to suggest any lack of operability unless otherwise indicated. Persons skilled in the art may make various changes in methods of preparing and using a composition, device, and/or system of the disclosure. Where desired, some embodiments of the disclosure may be practiced to the exclusion of other embodiments.

Also, where ranges have been provided, the disclosed endpoints may be treated as exact and/or approximations as desired or demanded by the particular embodiment. Where the endpoints are approximate, the degree of flexibility may vary in proportion to the order of magnitude of the range. For example, on one hand, a range endpoint of about 50 in the context of a range of about 5 to about 50 may include 50.5, but not 52.5 or 55 and, on the other hand, a range endpoint of about 50 in the context of a range of about 0.5 to about 50 may include 55, but not 60 or 75. In addition, it may be desirable, in some embodiments, to mix and match range endpoints. Also, in some embodiments, each figure disclosed (e.g., in one or more of the examples, tables, and/or drawings) may form the basis of a range (e.g., depicted value +/− about 10%, depicted value +/− about 50%, depicted value +/− about 100%) and/or a range endpoint. With respect to the former, a value of 50 depicted in an example, table, and/or drawing may form the basis of a range of, for example, about 45 to about 55, about 25 to about 100, and/or about 0 to about 100.

These equivalents and alternatives along with obvious changes and modifications are intended to be included within the scope of the present disclosure. Accordingly, the foregoing disclosure is intended to be illustrative, but not limiting, of the scope of the disclosure as illustrated by the appended claims.

The title, abstract, background, and headings are provided in compliance with regulations and/or for the convenience of the reader. They include no admissions as to the scope and content of prior art and no limitations applicable to all disclosed embodiments.

### EXAMPLES

Some specific example embodiments of the disclosure may be illustrated by one or more of the examples provided herein.

### Example 1

### Degradable Test Formulas

Five degradable rubber compositions were created using varying polymer distributions to compare the difference in degradation of the rubber formulas in a 3% brine solution at 200° F. (93.3° C.). Degradation properties were determined by measured changes in physical properties over time, and visual observations of the rubber materials. Table 13. illustrates the PHR polymer distribution of natural rubber, polyurethane, styrene butadiene rubber (SBR), and 30 mesh rubber grindings in each of the five degradable rubber compositions.

TABLE 13
PHR Polymer Distribution for the Five Compounds Tested

| | 2A | 2B | 3A | 3B | 3C |
|---|---|---|---|---|---|
| Natural Rubber | — | 55 | 30 | 50 | 70 |
| Polyurethane | — | — | 70 | 50 | 30 |
| Styrene Butadiene Rubber | 67 | — | — | — | — |
| 30 Mesh Rubber Grindings | 66 | 80 | — | — | — |

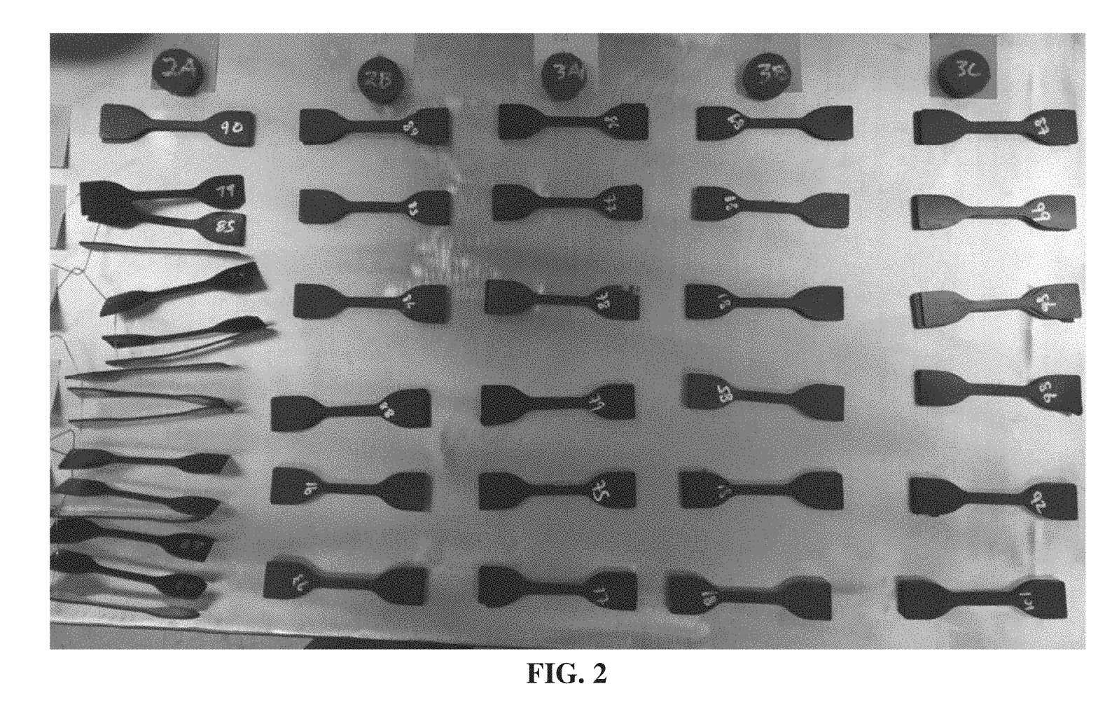

Once the five degradable rubber compositions were cured, dumbbell shaped samples were formed. Samples were tested after 3 days, 8 days, 14 days, 21 days, and 28 days. For each testing period, 3 dumbbell shaped samples were tested. FIG. 2 illustrates initial dumbbell shaped samples. Compression set buttons were molded for each degradable rubber composition. Incision testing was performed on the compression set buttons after each time increment. For each incision test, the tip of a square shank was pressed, with aim to puncture, individually against each of the compression set buttons

Initial rheometer testing was done on all five degradable rubber compositions. Table 14 illustrates the initial rheometer analysis of samples 2A, 2B, 3A, 3B, and 3C.

TABLE 14
MDR 2000 - 4 Minutes at 350° F. - 1° Arc

| Parameters | 2A | 2B | 3A | 3B | 3C |
|---|---|---|---|---|---|
| ML, lb-in | 5.94 | 8.57 | 0.98 | 1.20 | 1.46 |
| TS2, m:s | ≈0:30 | 1:31 | 0:56 | 0:40 | 0:36 |
| T90, m:2 | 1:05 | 2:51 | 1:48 | 1:01 | 0:53 |
| MH, lb-in | 25.57 | 12.48 | 10.99 | 10.47 | 10.19 |

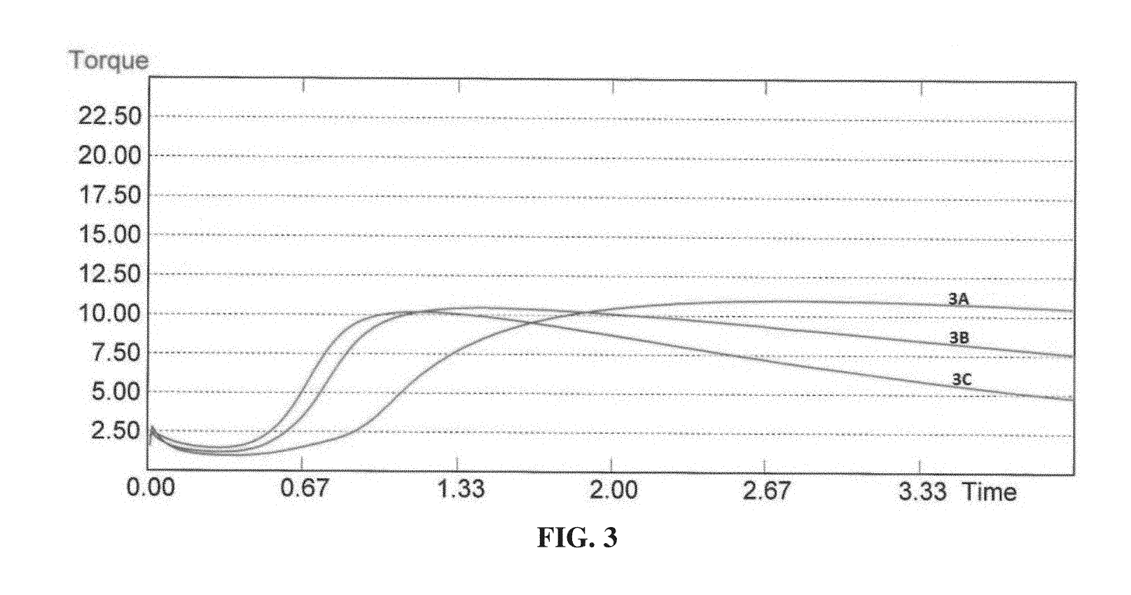

Rheometer curves for samples 3A, 3B, and 3C are illustrated in FIG. 3, which illustrates the differing levels of reversion related to the ratio of polyurethane to natural rubber of each degradable rubber composition. Of the three degradable rubber compositions, sample 3A, the sample with the highest relative distribution of natural rubber, exhibited the highest reversion.

Table 15 illustrates the initial physical properties for each degradable rubber composition. The initial physical properties are the cure conditions, hardness (Shore A), tensile strength, elongation, and specific gravity.

TABLE 15
Initial Physical Properties of the
Five Degradable Rubber Compositions

| Parameters | 2A | 2B | 3A | 3B | 3C |
|---|---|---|---|---|---|
| Cure Conditions, | 10//300 | 25/300 | 15/300 | 7/300 | 6/300 |
| min/° F.(° C.) | (148.9) | (148.9) | (148.9) | (148.9) | (148.9) |
| Hardness, (Shore A) | 80 | 70 | 64 | 59 | 55 |
| Tensile (PSI) | 1172 | 1286 | 3351 | 2936 | 3050 |
| Elongation, (%) | 223 | 373 | 470 | 511 | 614 |
| Specific Gravity | 1.25 | 1.20 | 1.21 | 1.15 | 1.09 |

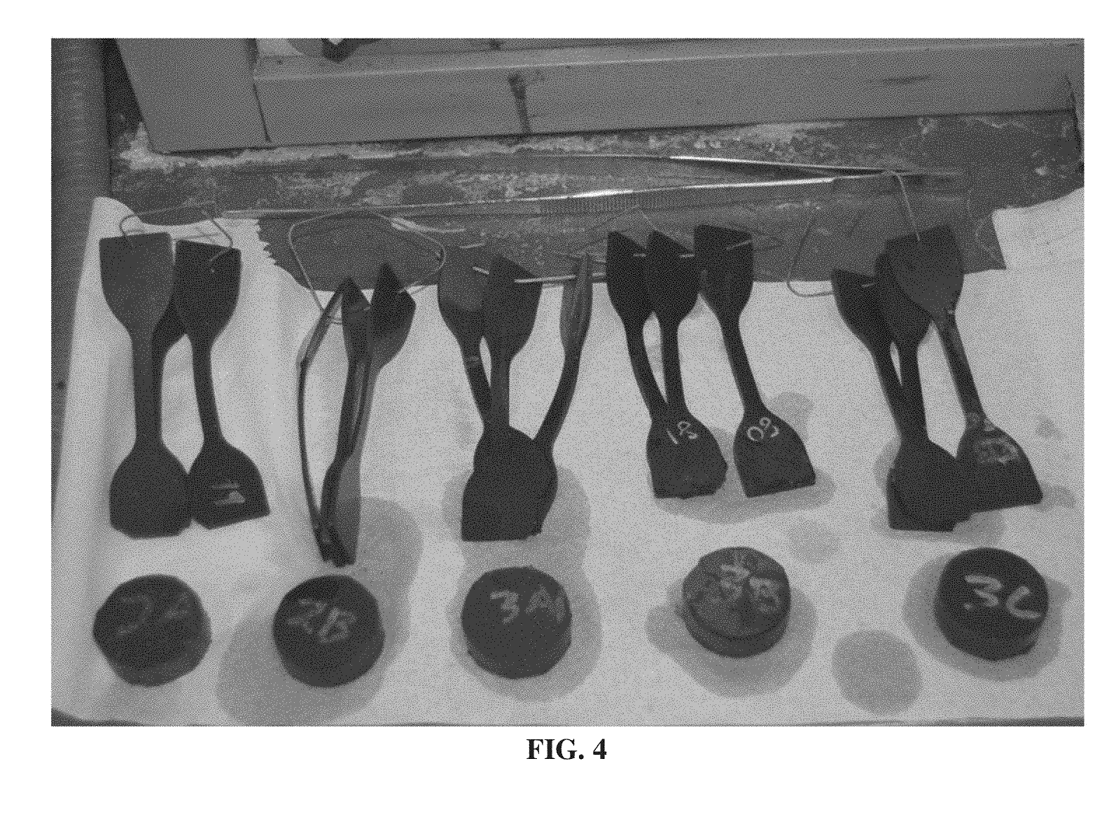

Dumbbell shaped degradable rubber compositions were placed in five separate jars containing a 3% brine solution, wherein samples were obtained to test weekly for up to four weeks (28 days). At each time interval, samples were removed for tests, the tests comprising tensile strength analysis and incision analysis. FIGS. 4-13 illustrate the details and observations of each testing increment.

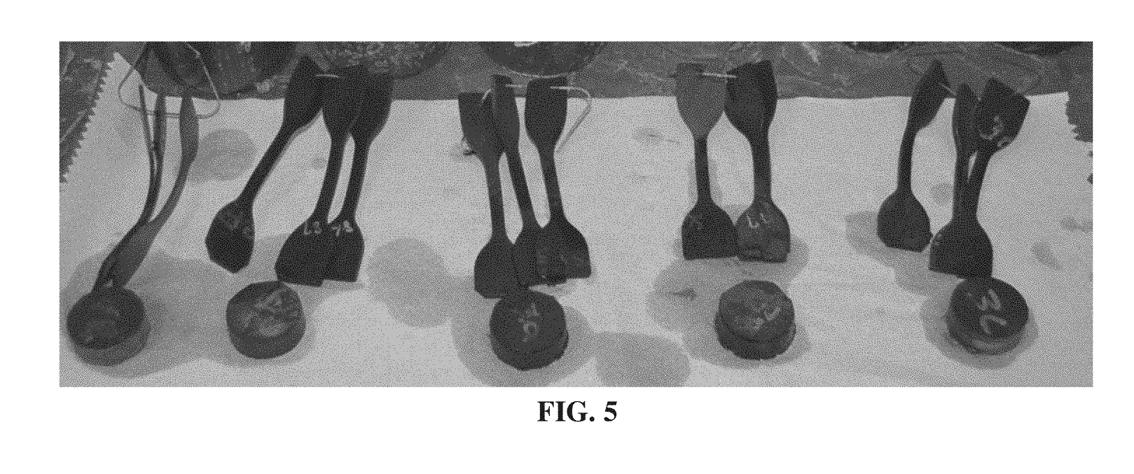

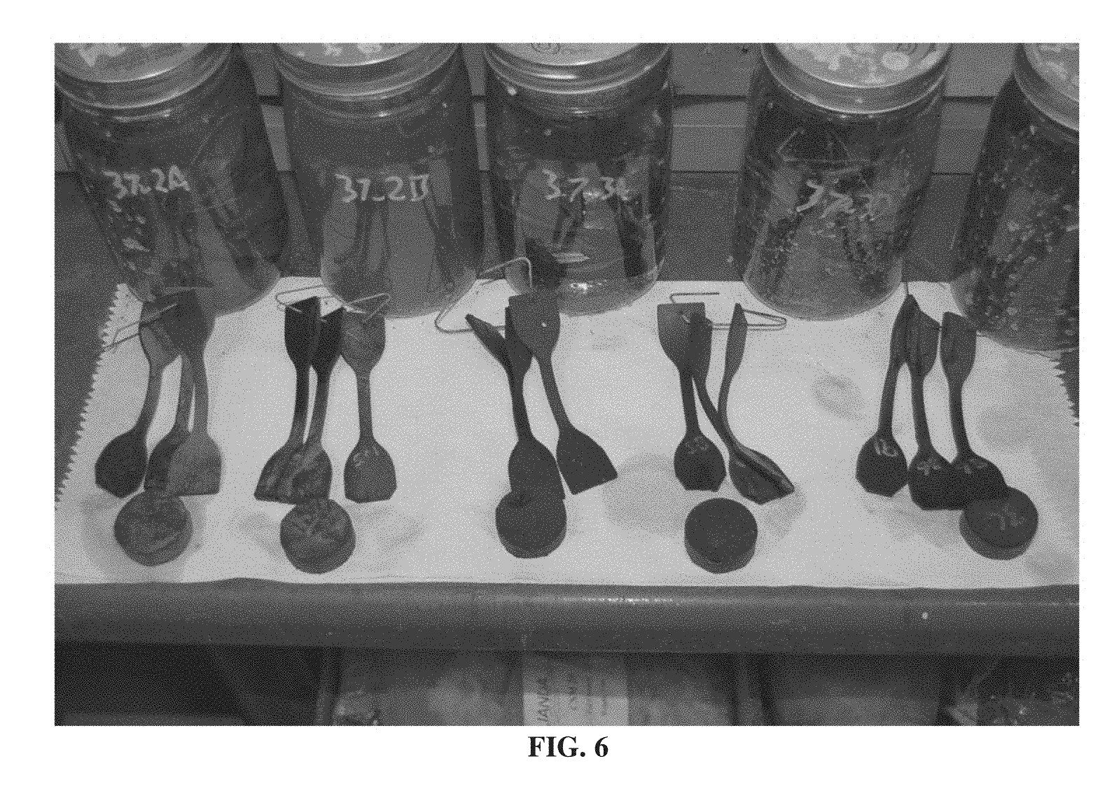

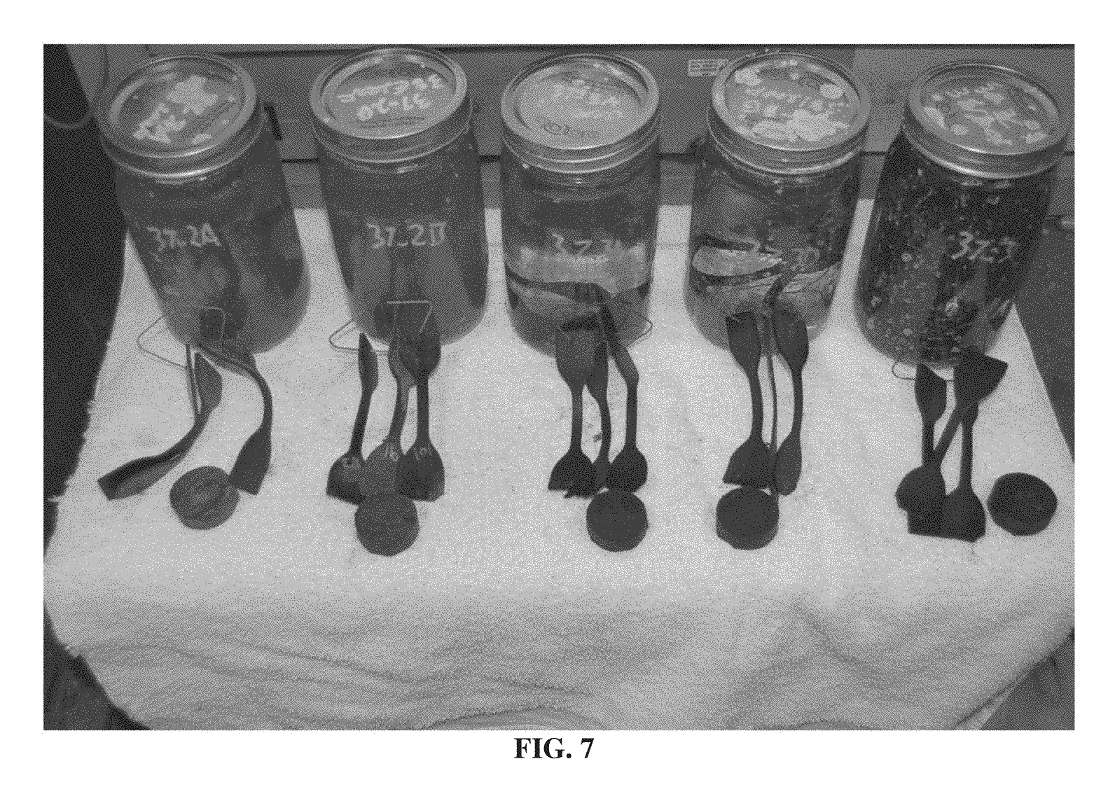

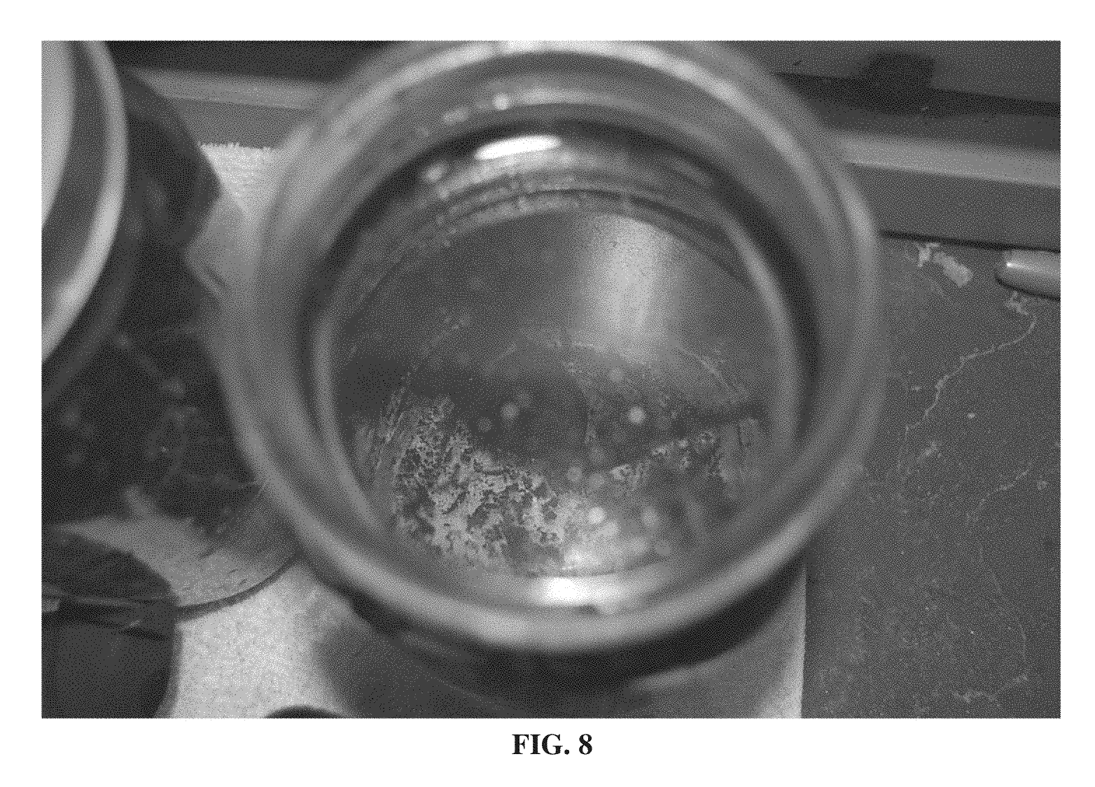

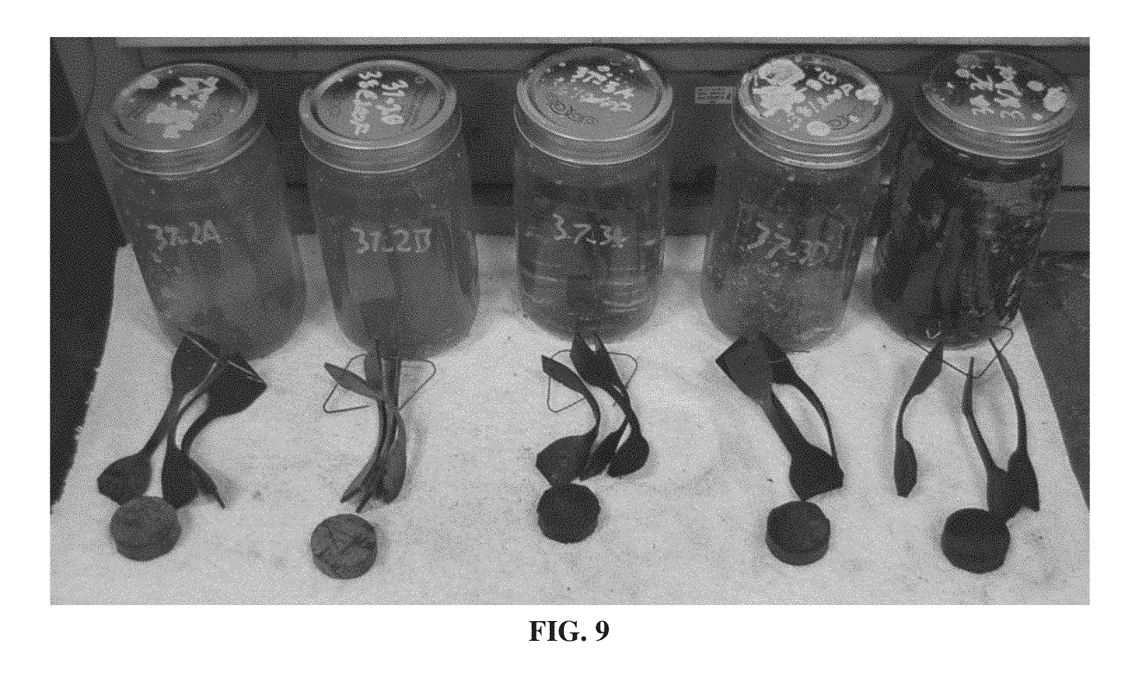

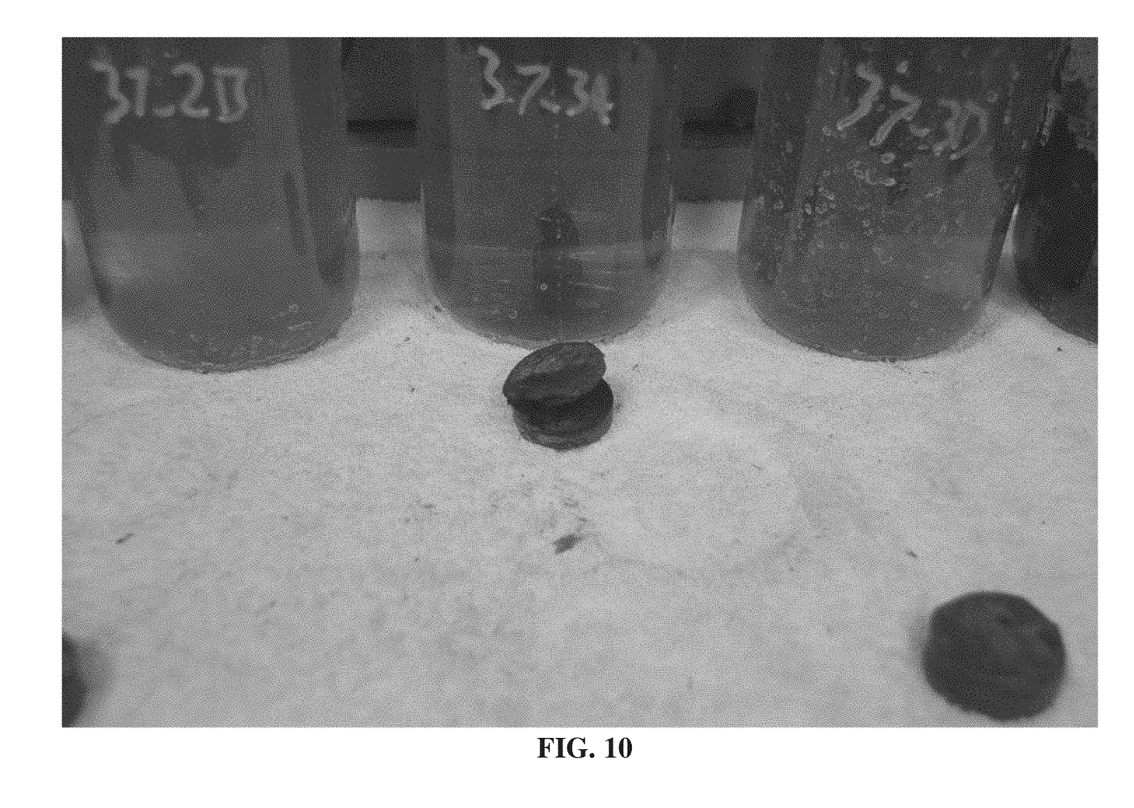

FIG. 4 illustrates that after three days of immersion, compositions 3A, 3B, and 3C are flimsier and sticker than 2A and/or 2B. FIG. 5 illustrates that after 8 days of immersion, compositions 3A, 3B, and 3C become even sticker in comparison to three days of immersion, whereas compositions 2A and 2B remained comparable to the three days of immersion samples. FIG. 6 illustrates that after 14 days, compositions 3A, 3B, and 3C became less sticky in comparison to previous immersion times, but the compositions became more brittle in comparison to previous sample periods. After 14 days, composition 3A was easily pierceable with the tip of a square shank in the incision test. FIG. 7 illustrates that after 21 days of immersion, all composition had become more brittle in comparison to the initial time. Composition 3A was even more easily pierceable with the tip of a square shank in the incision test in comparison to the 14 day time interval. FIG. 8 illustrates that after 21 days, degradable rubber composition 3C exhibited flakes of dissolved rubber. Degradable rubber composition button 3C was not pierced as easily as degradable rubber composition button 3A. FIG. 9 illustrates that after 28 days, compositions 2A and 2B exhibited porosity on their outer layer. Degradable rubber composition 3A was easily pulled apart and/or pierced in the incision test in comparison to samples from previous time intervals. Degradable rubber compositions 3B and 3C did not pull apart as easily as 3A, but could be pierced in the incision test. FIG. 10 illustrates that degradable rubber composition 3A button readily separated in the incision test after 28 days of testing.

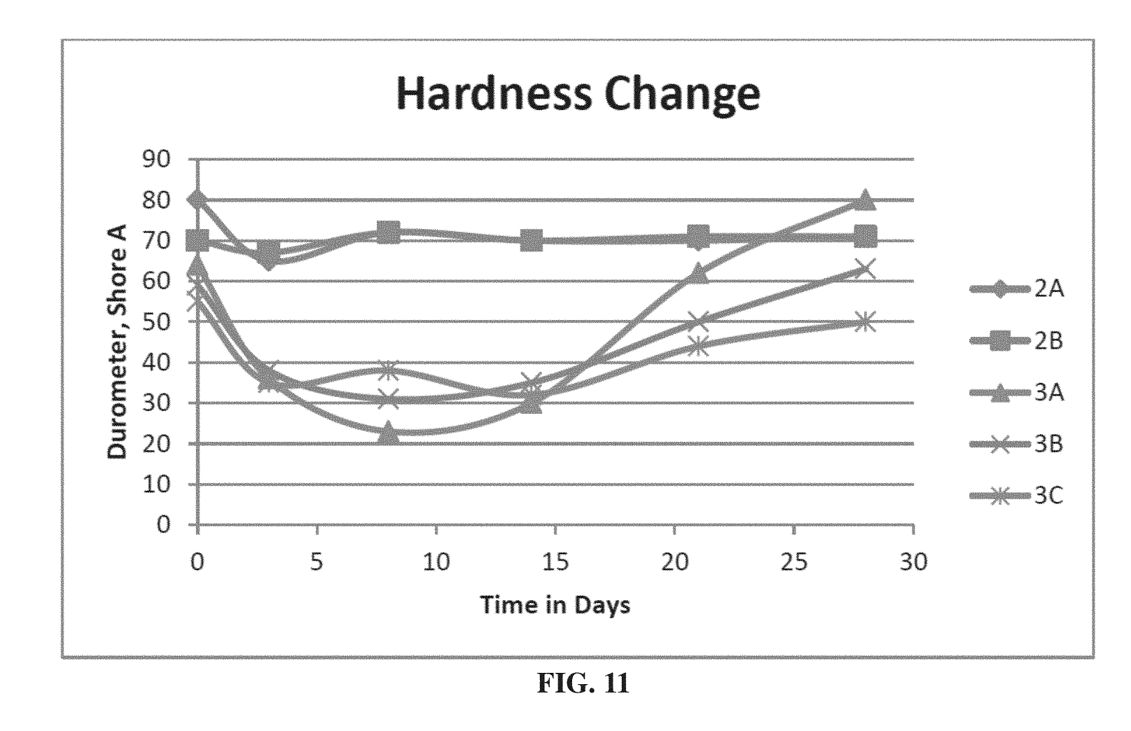

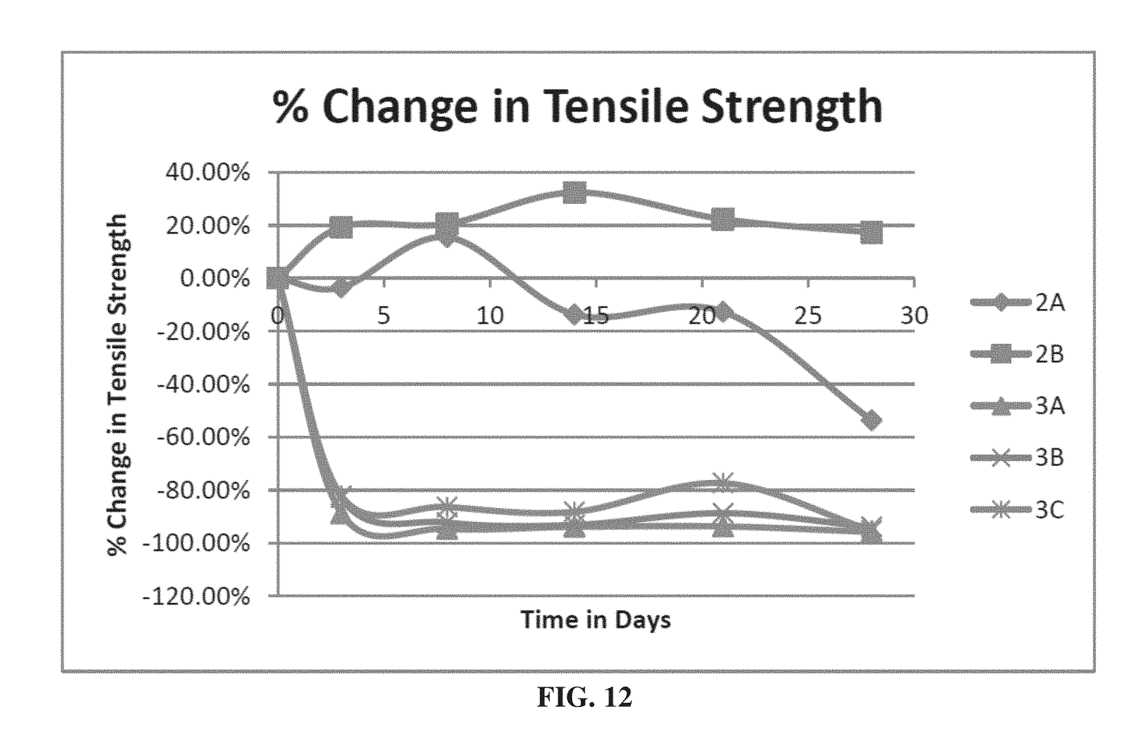

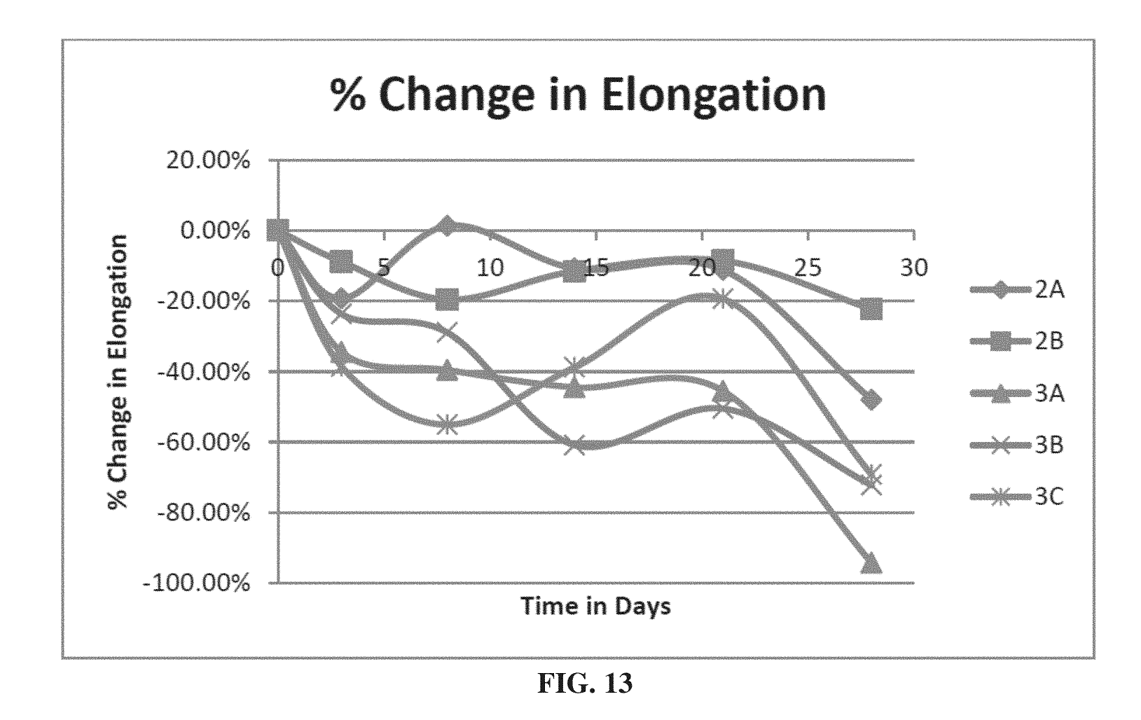

FIG. 11 illustrates the hardness measurement of the compositions 2A, 2B, 3A, 3B, and 3C over the course of the 28 days. The graph illustrates how 3A, 3B, and 3C dropped significantly until they became brittle and harder from week two to week four. FIG. 12 illustrates the change in ultimate tensile strength. The tensile strength of composition 2A decreased gradually over time. The tensile strength of composition 2B increased gradually over time. The tensile strength of compositions 3A, 3B, and 3C decreased by the first time interval and then maintained the loss of properties through the duration of the test. FIG. 13 illustrates the change in elongation for compositions 2A, 2B, 3A, 3B, and 3C. All five composition exhibited a final decrease in elongation properties in comparison to the initial time interval. Degradable rubber composition 3A exhibited the highest change in % change in elongation in comparison to compositions 2A, 2B, 3B, and 3C.

### Example 2

### Specific Example Embodiments of a Degradable Rubber Composition

A degradable rubber composition may be configured to have one or more of the desired qualities disclosed in this application including, for example, swellability, density of crosslinks, tolerance of salinity, curing temperature, among others, by adjusting the composition of one or more components. Examples of degradable compositions are provided in Table 16.

TABLE 16
Degradable rubber compositions

| | Formulation (wt. %) | | | | | | | | | | | | | | | |
|---|---|---|---|---|---|---|---|---|---|---|---|---|---|---|---|---|
| | A | B | C | D | E | F | G | H | I | J | K | L | M | N | O | P |
| A natural rubber | 21.5 | 21 | 22 | 27 | 29.5 | 22 | 25.6 | 23.6 | 18.4 | 20.9 | 25.4 | 27.5 | 21.8 | 24.5 | 21.4 | 19.7 |
| A polyurethane | 56.2 | 60.3 | 56.3 | 52.3 | 50 | 53.4 | 54.5 | 55.1 | 57.4 | 56.7 | 49.8 | 47 | 58 | 54 | 57 | 45.9 |
| A zinc stearate | 0.2 | 0.5 | 1.1 | 0.9 | 0.6 | 0.7 | 0.6 | 0.6 | 0.5 | 0.8 | 0.2 | 0.4 | 0.7 | 1 | 0.6 | 0.5 |
| A complex of zinc | 0.5 | 0.2 | 0.4 | 0.2 | 0.8 | 0.4 | 0.7 | 0.3 | 0.1 | 0.5 | 0.15 | 0.9 | 0.8 | 0.6 | 0.2 | 0.3 |
| chloride and a | | | | | | | | | | | | | | | | |
| benzothiazole disulfide | | | | | | | | | | | | | | | | |
| A carbon black | 15.6 | 13.5 | 15.2 | 15.9 | 14.5 | 18.5 | 13 | 15.7 | 18.4 | 15.4 | 17.5 | 18.7 | 12.9 | 14.1 | 16.7 | 29.5 |
| A benzothiazole | 2.8 | 2.1 | 2.4 | 2 | 2.5 | 2.7 | 2.3 | 2.6 | 2.5 | 2.4 | 3 | 2.8 | 2.8 | 3 | 2.4 | 2.2 |
| disulfide | | | | | | | | | | | | | | | | |
| A thiuram disulfide | 1 | 0.3 | 0.4 | 0.5 | 0.2 | 0.3 | 0.7 | 0.2 | 0.8 | 0.6 | 0.95 | 1.2 | 0.9 | 0.4 | 0.1 | 0.3 |
| A sulfur | 2 | 1.5 | 1.9 | 1.1 | 1 | 1.6 | 1.5 | 1.7 | 1.2 | 2.1 | 2 | 1.2 | 1 | 1.9 | 1.4 | 1.5 |
| A stearic acid | 0.2 | 0.6 | 0.3 | 0.1 | 0.9 | 0.4 | 1.1 | 0.2 | 0.7 | 0.6 | 1 | 0.3 | 1.1 | 0.5 | 0.2 | 0.2 |

### Example 3

### Physical Property Analysis of a Degradable Rubber Composition

A degradable rubber composition comprising 30 Phr natural rubber, 70 Phr millithane 76, 45 Phr, N326 black, 0.7 Phr zinc stearate, 0.3 Phr stearic acid, 2.35 Phr sulfur, 3.3 Phr MBTS, 0.4 Phr Thanecure ZM, and 0.45 Phr TBzTD was analyzed for physical properties (Table 17). In some embodiments, the hardness can be adjusted to about 110 for Shore A, B, or C.

TABLE 17
Physical Property of a Degradable Rubber Composition

| Physical Property | Value |
|---|---|
| Cure Conditions | 20/300 |
| (min/° F. (° C.) | (148.9) |
| Specific Gravity | 1.27 |
| Hardness (Shore A) | 76 |
| Tensile (PSI) | 3007 |
| Elongation (%) | 623 |
| 100% Modulus (PSI) | 496 |
| 200% Modulus (PSI) | 997 |
| 300% Modulus (PSI) | 1520 |
| Heat Deflection (mm at 23° C.) | 0.25 |

### Example 4

### Fatty Acid and Metal Oxide Effects on the Degradation of a Degradable Rubber Composition

The relative rates of degradation of various rubber compositions comprising a polyester polyurethane elastomer comprising adipate polyol may be tested. Specifically, the rates of degradation of the following compositions may be tested:
a first degradable rubber composition comprising 4 Phr of stearic acid and 4 Phr of zinc oxide,
a second degradable rubber composition comprising 3 Phr of stearic acid and 3 Phr of zinc oxide, and
a third degradable rubber composition comprising 2 Phr of stearic acid and 2 Phr of zinc oxide.
   In addition, a control may be used which has no stearic acid or zinc oxide. Each composition otherwise may have a similar composition and may be exposed to similar conditions. After such exposure, rates of degradation may be evaluated. Without being limited to any mechanism of action, stearic acid may extend the molecular chain of the adipate while additionally exponentially increasing the adsorption of the hydroxyl group already pre-established in the polyester polyurethane elastomer. Testing may be performed at 200 F (93.3° C.). Degradation testing may be performed in a solution of 3% KCl by weight in water. A hand pressure (e.g., manual manipulation by a human investigator) may be supplied to the rubber compositions during the testing. The first degradable rubber composition may degrade faster than the second and third degradable rubber compositions. Additionally, the first degradable rubber composition may crack during vulcanization. A combination of the stearic acid and the zinc oxide may produce an accelerated catalytic break down in that example composition, which may arise from an incompatibility with zinc and may additionally be reactive with the double bonds of the fatty acid. If the control composition degrades in about 2 weeks, the third degradable rubber composition may degrade faster, for example, in one and three quarter weeks, and the second degradable rubber composition may degrade faster still, for example, in about one and a half weeks. Prior to degradation, the control, first degradable rubber composition, second degradable rubber composition, and third degradable rubber composition may hold a pressure of about 10,000 psi (68,948 kPa), for example, in the context of a well where there is little or no lateral force. Additionally, degradation of a degradable rubber composition may result in range of fragments or pieces, substantially all of which are too small to foul clog up or obstruct flow inside a pipeline.

What is claimed is:

1. A degradable rubber composition comprising:
at least one natural rubber;
at least one polyurethane;
at least one sulfur curing agent; and
at least one complex comprising zinc chloride and a disulfide,
wherein the degradable rubber composition is degradable in an aqueous composition.

2. The degradable rubber composition of claim 1 further comprising:
at least one carbon black;
at least one zinc soap;
at least one vulcanization accelerant;
at least one polymerization accelerant;
at least one stearic acid;
or combinations thereof.

3. The degradable rubber composition of claim 1, wherein the aqueous composition is selected from the group consisting of water, water solutions, downhole water-based solutions, aqueous-based solutions, and at least one brine.

4. The degradable rubber composition of claim 1, wherein the degradable rubber composition degrades from about 25% to about 90% within a period of time, the period of time selected from the group consisting of about 1 day, about 3 days, about 7 days, about 14 days, about 21 days, and about 28 days.

5. The degradable rubber composition of claim 1, wherein the degradable rubber composition degrades from about 25% to about 90% at a temperature, the temperature selected from the group consisting of about 50° F. (10° C.), about 75° F. (23.9° C.), about 100° F. (37.8° C.), about 125° F. (51.7° C.), about 150° F. (65.6° C.), about 175° F. (79.4° C.), about 200° F. (93.3° C.), about 225° F. (107.2° C.), about 250° F. (121.1° C.), about 275° F. (135° C.), and about 300° F. (148.9° C.).

6. The degradable rubber composition of claim 1, wherein the degradable rubber composition degrades from about 25% to about 90% within about 14 days at about 200° F. (93.3° C.).

7. The degradable rubber composition of claim 1, wherein the at least one natural rubber is present at a concentration ranging from about 10 wt. % to about 60 wt. % of the degradable rubber composition.

8. The degradable rubber composition of claim 1, wherein the at least one polyurethane is present at a concentration ranging from about 40 wt. % to about 70 wt. % of the degradable rubber composition

9. The degradable rubber composition of claim 1, wherein the at least one complex is present at a concentration ranging from about 0.8 wt. % to about 3.0 wt. % of the degradable rubber composition.

10. The degradable rubber composition of claim 1, wherein the at least one sulfur curing agent is present at a concentration ranging from about 0.8 wt. % to about 3.0 wt. % of the degradable rubber composition

11. The degradable rubber composition of claim 1, wherein the degradable rubber composition may be used in a swellable packer-conduit assembly.

12. A degradable swellable packer-conduit assembly comprising:
at least one conduit; and
at least one degradable rubber composition,
wherein the at least one degradable rubber composition comprises:
at least one natural rubber;
at least one polyurethane;
at least one sulfur curing agent; and
at least one complex comprising zinc chloride and a disulfide,
wherein the at least one degradable rubber composition is degradable in an aqueous composition.

13. The degradable swellable packet-conduit assembly of claim 12, wherein the aqueous composition is selected from the group consisting of water, water solutions, downhole water-based solutions, aqueous-based solutions, and at least one brine.

14. The degradable swellable packet-conduit assembly of claim 12, wherein the degradable rubber composition degrades from about 25% to about 90% within a period of time, the period of time selected from the group consisting of about 1 day, about 3 days, about 7 days, about 14 days, about 21 days, and about 28 days.

15. The degradable rubber composition of claim 12, wherein the degradable rubber composition degrades from about 25% to about 90% at a temperature, the temperature selected from the group consisting of about 50° F. (10° C.), about 75° F. (23.9° C.), about 100° F. (37.8° C.), about 125° F. (51.7° C.), about 150° F. (65.6° C.), about 175° F. (79.4° C.), about 200° F. (93.3° C.), about 225° F. (107.2° C.), about 250° F. (121.1° C.), about 275° F. (135° C.), and about 300° F. (148.9° C.).

16. The degradable rubber composition of claim 12, wherein the degradable rubber composition degrades from about 25% to about 90% within about 14 days at about 200° F. (93.3° C.).

17. The degradable swellable packet-conduit assembly of claim 12, wherein the at least one natural rubber is present at a concentration ranging from about 10 wt. % to about 60 wt. % of the degradable rubber composition.

18. The degradable swellable packet-conduit assembly of claim 12, wherein the at least one polyurethane is present at a concentration ranging from about 40 wt. % to about 70 wt. % of the degradable rubber composition

19. The degradable swellable packet-conduit assembly of claim 12, wherein the at least one complex is present at a concentration ranging from about 0.8 wt. % to about 3.0 wt. % of the degradable rubber composition.

20. The degradable swellable packet-conduit assembly of claim 12, wherein the at least one sulfur curing agent is present at a concentration ranging from about 0.8 wt. % to about 3.0 wt. % of the degradable rubber composition.

21. The degradable swellable packet-conduit assembly of claim 12, wherein the degradable rubber composition is capable of swelling upon contacting the aqueous composition, wherein the degradable rubber composition has already been cured.

22. The degradable swellable packet-conduit assembly of claim 12, wherein the aqueous composition comprises water, water solutions, downhole water-based solutions, aqueous-based solutions, at least one brine, and combinations thereof.

23. The degradable swellable packet-conduit assembly of claim 12, wherein the degradable rubber composition is capable of swelling at a temperature of at least about 275° F. (135° C.).

24. The degradable swellable packet-conduit assembly of claim 12, wherein the degradable rubber composition is capable of swelling at a pressure, the pressure selected from the group consisting of at least about 3,000 psi (20684 kPa), at least about 4,000 psi (27,579 kPa), at least about 5,000 psi (34,474 kPa), at least about 6,000 psi (41,369 kPa), at least about 7,000 psi (48,263 kPa), at least about 8,000 psi (55,158 kPa), at least about 9,000 psi (62,053 kPa), at least about 10,000 psi (68,948 kPa), and at least about 11,000 psi (75,842 kPa).

25. A method of sealing an annular region between a wellbore wall and a degradable swellable packer-conduit assembly, the method comprising:
(a) disposing the degradable swellable packer-conduit assembly between the wellbore wall and a pipe; and
(b) contacting at least a portion of the degradable swellable packer-conduit assembly with an aqueous composition,
wherein the degradable swellable packer-conduit assembly comprises at least one conduit and at least one degradable rubber composition, the at least one degradable rubber composition comprising:
at least one natural rubber;
at least one polyurethane;
at least one sulfur curing agent; and
at least one complex comprising zinc chloride and a disulfide,
wherein the degradable rubber composition is degradable in the aqueous composition.

26. The method of claim 25 further comprising:
(c) degrading at least a portion of the degradable swellable packer-conduit assembly.

27. The method of claim 25, wherein the aqueous composition comprises water solutions, downhole water-based solutions, aqueous-based solutions, at least one brine, or combinations thereof.

27. The method of claim 25, wherein the degradable rubber composition degrades from about 25% to about 90% within a period of time, the period of time selected from the group consisting of about 1 day, about 3 days, about 7 days, about 14 days, about 21 days, and about 28 days.

28. The degradable rubber composition of claim 25, wherein the degradable rubber composition degrades from about 25% to about 90% at a temperature, the temperature selected from the group consisting of about 50° F. (10° C.), about 75° F. (23.9° C.), about 100° F. (37.8° C.), about 125° F. (51.7° C.), about 150° F. (65.6° C.), about 175° F. (79.4° C.), about 200° F. (93.3° C.), about 225° F. (107.2° C.), about 250° F. (121.1° C.), about 275° F. (135° C.), and about 300° F. (148.9° C.).

29. The degradable rubber composition of claim 25, wherein the degradable rubber composition degrades from about 25% to about 90% within about 14 days at about 200° F. (93.3° C.).

30. The method of claim 25, wherein the at least one natural rubber is present at a concentration ranging from about 10 wt. % to about 60 wt. % of the degradable rubber composition.

31. The method of claim 25, wherein the at least one polyurethane is present at a concentration ranging from about 40 wt. % to about 70 wt. % of the degradable rubber composition.

32. The method of claim 25, wherein the at least one complex is present at a concentration ranging from about 0.8 wt. % to about 3.0 wt. % of the degradable rubber composition.

33. The method of claim 25, wherein the at least one sulfur curing agent is present at a concentration ranging from about 0.8 wt. % to about 3.0 wt. % of the degradable rubber composition.

34. The method of claim 25, wherein the degradable swellable packer-conduit assembly swells by about 20% to about 250% by volume, wherein the degradable swellable packer-conduit assembly is subjected to a pressure, the pressure selected from the group consisting of at least about 3,000 psi (20684 kPa), at least about 4,000 psi (27,579 kPa), at least about 5,000 psi (34,474 kPa), at least about 6,000 psi (41,369 kPa), at least about 7,000 psi (48,263 kPa), at least about 8,000 psi (55,158 kPa), and at least about 10,000 psi (68,948 kPa).

35. The method of claim 25, wherein the degradable swellable packer-conduit assembly swells by about 20% to about 250% by volume, wherein swelling occurs within a period of time, the period of time selected from the group consisting of about 1 day, about 2 days, about 3 days, about 4 days, and about 5 days.

36. A method of degrading a degradable swellable packer-conduit assembly, the method comprising:
(a) disposing a swellable packer-conduit assembly between a wellbore wall and a pipe;
(b) contacting at least a portion of the degradable swellable packer-conduit assembly with an aqueous composition; and
(c) degrading at least a portion of the degradable swellable packer-conduit assembly,
wherein the degradable swellable packer-conduit assembly comprises a conduit and at least one degradable rubber composition, the at least one degradable rubber composition comprising:
at least one natural rubber;
at least one polyurethane;
at least one sulfur curing agent; and
at least one complex comprising zinc chloride and a disulfide.

37. The method of claim 36, wherein the degradable rubber composition degrades from about 25% to about 90% within a period of time, the period of time selected from the group consisting of about 1 day, about 3 days, about 7 days, about 14 days, about 21 days, and about 28 days.

38. The degradable rubber composition of claim 36, wherein the degradable rubber composition degrades from about 25% to about 90% at a temperature, the temperature selected from the group consisting of about 50° F. (10° C.), about 75° F. (23.9° C.), about 100° F. (37.8° C.), about 125° F. (51.7° C.), about 150° F. (65.6° C.), about 175° F. (79.4° C.), about 200° F. (93.3° C.), about 225° F. (107.2° C.), about 250° F. (121.1° C.), about 275° F. (135° C.), and about 300° F. (148.9° C.).

39. The degradable rubber composition of claim 36, wherein the degradable rubber composition degrades from about 25% to about 90% within about 14 days at about 200° F. (93.3° C.).

40. The method of claim 36, wherein the degradable swellable packer-conduit assembly swells by about 20% to about 250% by volume, wherein the degradable swellable packer-conduit assembly is subjected to a pressure, the pressure selected from the group consisting of at least about 3,000 psi (20684 kPa), at least about 4,000 psi (27,579 kPa), at least about 5,000 psi (34,474 kPa), at least about 6,000 psi (41,369 kPa), at least about 7,000 psi (48,263 kPa), and at least about 8,000 psi (55,158 kPa).

41. The method of claim 36, wherein the degradable swellable packer-conduit assembly swells by about 20% to about 250% by volume, wherein swelling occurs within a period of time, the period of time selected from the group consisting of about 1 day, about 2 days, about 3 days, about 4 days, and about 5 days.

42. The method of claim 36, wherein the at least one natural rubber is present at a concentration ranging from about 10 wt. % to about 60 wt. % of the degradable rubber composition.

43. The method of claim 36, wherein the at least one polyurethane is present at a concentration ranging from about 40 wt. % to about 70 wt. % of the degradable rubber composition.

44. The method of claim 36, wherein the at least one complex is present at a concentration ranging from about 0.8 wt. % to about 3.0 wt. % of the degradable rubber composition.

45. The method of claim 36, wherein the at least one sulfur curing agent is present at a concentration ranging from about 0.8 wt. % to about 3.0 wt. % of the degradable rubber composition.

46. A degradable rubber composition comprising:
at least one haloid polymer;
at least one natural rubber;
at least one polyurethane;
at least one sulfur curing agent; and
at least one complex comprising zinc chloride and a disulfide,
wherein the degradable rubber composition is degradable in an aqueous composition.
